(19) United States
(12) Patent Application Publication
(10) Pub. No.: US 2025/0244082 A1
(43) Pub. Date: Jul. 31, 2025

(54) THREE-DIMENSIONAL SPIRAL HEAT EXCHANGER WITH FLAT, CURVED, ANGLED, AND CORRUGATE PLATES

(71) Applicant: Hamid Kiani Salmi, I, Isfahan (IR)

(72) Inventor: Hamid Kiani Salmi, I, Isfahan (IR)

(73) Assignee: Hamid Kiani Salmi, I, Isfahan, IS (IR)

(21) Appl. No.: 18/833,410

(22) PCT Filed: Feb. 5, 2022
(86) PCT No.: PCT/IB2022/051014

§ 371 Date: Jul. 26, 2024

(51) Int. Cl. F28D 9/04

(52) U.S. Cl. CPC F28D 9/04

(57) ABSTRACT

Three-dimensional spiral heat exchanger with flat, curved, angled, and corrugate plates comprising: a set of three-dimensional spiral created by scaling and rotating of a planar geometry relative to a point, which forms at least two duct wherein each duct has at least one inlet and at least one outlet, one of which is located in the center of the heat exchanger and the other is located on the shell of heat exchanger, a pair of tubes which are connected to the first duct, a pair of tubes which are connected to the second duct, and some separator sheets in the center of heat exchanger.

### TECHNICAL FIELD

The present invention relates to heat exchangers and, in particular, to three-dimensional heat exchangers or multi-shell heat exchangers comprising at least two three-dimensional shells wherein one shell encloses the other without intersection.

### BACKGROUND ART

The pre-existing spiral heat exchanger consists of two flat plates that bend in a spiral shape, and there is also another plate in the center of the heat exchanger that separates the two ducts of the heat exchanger. In these types of heat exchanger, two fluids do not mix. The geometry of the main spiral is planar; in fact, the curve of spiral of the heat exchanger is extruded. In this document these type of the heat exchanger called planar heat exchanger.

Angular, curved, or convex plates can be used instead of flat plates in a plate spiral heat exchanger. (FIGS. 2 & 3). Angled plates can be used to design plate spiral heat exchangers. (FIGS. 4 & 5). Corrugated plates can be used to build a spiral heat exchanger.

Spiral heat exchangers can be designed so that the volume of their two ducts is not equal. Similarly, a planar spiral heat exchanger with curved, broken, grooved and corrugate plates can be made in such a way that the volume of its two ducts is unequal. (FIGS. 10 to 18).

FIGS. 1 to 18 related to prior art or small modification of existed heat exchangers.

### SUMMARY OF INVENTION

The summary of disclosed invention is intended to provide an overview of the subject matter of the invention, and is not intended to identify essential elements or key elements of the subject matter, nor is it intended to be used to determine the scope of the claimed implementations.

Three-dimensional spiral heat exchanger with flat, curved, angled, and corrugate plates comprising:
a set of nested shells surface, wherein to form a three-dimensional spiral, the two-dimensional geometry scales relative to a point, simultaneously with the rotation around the axis of spiral, at least two duct wherein each duct has at least one inlet and at least one outlet, one of which is located in the center of the heat exchanger and the other is located on the shell, a pair of tubes which are connected to the first duct, a pair of tubes which are connected to the second duct, and; some separator plates in the center of heat exchanger.

### BRIEF DESCRIPTION OF DRAWINGS

The figures of the present document are intended to be illustrative, not limiting.

FIG. 1 shows a spiral heat exchanger that already existed in prior art.

FIG. 2 shows the use of curved plates to form a planar spiral heat exchanger.

FIG. 3 shows a section view of a planar spiral heat exchanger with bent plates.

FIG. 4 shows a spiral heat exchangers with angled plates.

FIG. 5 shows a section view of a spiral heat exchanger with angled plates.

FIG. 6 shows a spiral heat exchanger with corrugated plates.

FIG. 7 shows a section view of spiral heat exchanger with corrugated plates.

FIG. 8 shows a spiral heat exchanger with two unequal duct.

FIG. 9 shows a section view of a planar spiral heat exchanger with two unequal duct.

FIG. 10 shows a spiral heat exchanger with curved plates and the different volume of two unequal ducts.

FIG. 11 shows a section view of spiral heat exchanger with curved plates and two unequal ducts.

FIG. 12 shows a planar spiral heat exchanger with curved plates and the volume of two unequal ducts.

FIG. 13 shows a spiral heat exchanger with angled plates and of two unequal ducts.

FIG. 14 shows a planar spiral heat exchanger with angled plates and the volume of two unequal ducts in the cut state.

FIG. 15 shows a planar spiral heat exchanger with angled plates and the volume of two unequal ducts.

FIG. 16 shows a planar spiral heat exchanger with corrugated plates and two unequal ducts.

FIG. 17 shows a spiral heat exchanger with corrugated plates and the volume of two unequal ducts.

FIG. 18 shows a section view of planar spiral heat exchanger with corrugated plates and the volume of two unequal ducts.

FIG. 19 shows the triangular and hexagonal for reference geometry to creating a three-dimensional spiral shell.

FIG. 20 shows the semicircular reference geometry for forming a three-dimensional spiral shell.

FIG. 21 shows a three-dimensional spiral shell and a nested three-dimensional spiral shell with a triangular reference geometry.

FIG. 22 shows a three-dimensional spiral shell and a nested three-dimensional spiral shell with a hexagonal reference geometry.

FIG. 23 shows a three-dimensional spiral shell and a nested three-dimensional spiral shell with the special reference geometry shown in FIG. 24.

FIG. 24 shows the reference geometry that led to the creation of the special three-dimensional spiral shell of FIG. 23.

FIG. 25 shows the planar spiral and a half of the semicircles which rotates around the spiral center and scaled.

FIG. 26 shows a spherical spiral shell without an axial tube and a spherical spiral shell with an axial tube (right figure).

FIG. 27 shows a section view of a double nested spherical spiral walls that form the spherical spiral heat exchanger wall.

FIG. 28 shows a section view of the wall of a spherical spiral heat exchanger.

FIG. 29 shows the use of a separator sheet in the center of the heat exchanger to create two separate paths.

FIG. 30 shows a three dimensional spiral heat exchanger wherein the first input path is to the center of the sphere and the input of another fluid in the other channel of the sphere.

FIG. 31 shows the basic spiral and rotation and scale of ellipses around the center of basic spiral.

FIG. 32 shows the basic spiral and the half-ellipses which is rotate and scale.

FIG. 33 shows a section view of the elliptical shell of the lens and the complete state.

FIG. 34 shows a section view of the wall of a spiral heat exchanger.

FIG. 35 shows the section view of a lenticular spiral heat exchanger wall.

FIG. 36 shows a section view of the wall of a lenticular spiral heat exchanger.

FIG. 37 shows the wall of a lenticular spiral heat exchanger.

FIG. 38 shows the wall of a lenticular spiral heat exchanger.

FIG. 39 shows the spiral plate and the half-ellipses centered on the spiral center that were tangent to the spiral plane.

FIG. 40 shows an oval spiral shell.

FIG. 41 shows an oval spiral heat exchanger.

FIG. 42 shows the top view of an oval spiral heat exchanger from.

FIG. 43 shows a section view of oval spiral heat exchanger.

FIG. 44 shows a three dimensional spiral heat exchanger whose reference geometry has broken lines.

FIG. 45 shows a section of a three-dimensional spiral heat exchanger whose reference geometry has broken lines.

FIG. 46 shows a section view of a three-dimensional spiral heat exchanger whose reference geometry has broken lines.

FIG. 47 shows a spiral three-dimensional heat exchanger whose reference geometry is rectangular.

FIG. 48 shows a cut view of a three-dimensional spiral heat exchanger whose reference geometry is rectangular.

FIG. 49 shows an example of a three-dimensional spiral heat exchanger with a reference geometry of straight and curved lines in combination.

FIG. 50 shows an example of a three-dimensional spiral heat exchanger with a reference geometry of straight and curved lines in combination.

FIG. 51 shows the change in the reference geometry of the spatial spiral over rotation around the axis.

FIG. 52 shows the three dimensional spiral heat exchanger in a position in which a bend is used instead of a connection between lines with sharp angles.

FIG. 53 shows a section view of a three dimensional spiral heat exchanger in a position where a bend is used instead of connecting lines with sharp angles.

FIG. 54 shows a three-dimensional spiral heat exchanger.

FIG. 55 shows a section view of a three-dimensional spiral heat exchanger with a distorted shell.

FIG. 56 shows a spherical spiral shell in the cut state.

FIG. 57 shows a section view of two nested spherical shells with a 90° phase difference.

FIG. 58 shows a spherical spiral heat exchanger in which the volume of the two ducts is unequal.

FIG. 59 shows a section view of a parabolic spiral heat exchanger with a different volume of two ducts in the.

FIG. 60 shows a section view of a heat exchanger with a 90° shell phase difference.

FIG. 61 shows a spiral heat exchanger wherein the volume of the two ducts is unequal.

FIG. 62 shows connection of an axial tube and two ducts in a lenticular spiral heat exchanger with two unequal duct volumes.

FIG. 63 shows an egg spiral heat exchanger in a situation where the volume of the two ducts is unequal.

FIG. 64 shows a section view of an oval spiral heat exchanger.

FIG. 65 shows how the axial pipes are connected in the oval heat exchanger.

FIG. 66 shows a three-dimensional spiral heat exchanger with two unequal duct and a reference geometry in dashed lines.

FIG. 67 shows a section view of a three-dimensional spiral heat exchanger showing the volume of two unequal ducts and the reference geometry of dashed lines.

FIG. 68 shows a three-dimensional spiral heat exchanger with two unequal duct and the connection of several tubes to the outer shell of the heat exchanger

FIG. 69 shows a three-dimensional of a spiral heat exchanger in which the diameter of the two axial tubes is unequal.

FIG. 70 shows a three-dimensional heat exchanger in which one of the ducts exchanges fluid direct (without a tube) with the environment.

FIG. 71 shows a view of a three-dimensional spiral heat exchanger in which one of the ducts at the end of the outer shell exchanges fluid directly (without a tube) with the environment.

FIG. 72 shows the connection of several pipes to the center of each duct.

FIG. 73 shows an integrated spiral heat exchanger with a combination of a three-dimensional spiral and a planar spiral heat exchanger.

FIG. 74 shows an integral spiral heat exchanger (a combination of a three dimensional spiral and a plate spiral) in which the center of the heat exchanger is formed by of cut tubes and separator plates.

FIG. 75 shows a spiral heat exchanger which is a combination of two ducts with different volumes (a combination of three dimensional spiral and planar spiral heat exchanger).

FIG. 76 shows a section view of the integrated spiral heat exchanger, which has two ducts with different volumes (combination of three dimensional spiral and planar spiral heat exchanger).

FIG. 77 shows the duct connected to the heat exchanger to remove the distilled fluid from the inner duct.

FIG. 78 shows a heat exchanger with a distillation tube.

FIG. 79 shows an integrated heat exchanger with a duct connection to remove distilled fluid.

FIG. 80 shows a section view of a combined spiral heat exchanger for distillation.

FIG. 81 shows the tube connected to the heat exchanger to remove the evaporated fluid.

FIG. 82 shows the use of different types of blades in spherical spiral heat exchangers.

FIG. 83 shows connection of two nested pipes from the top of the heat exchanger in order to inject two reactive fluids into the center of the heat exchanger.

FIG. 84 shows the use of two inlet pipes on the outer shell for one duct and two axially nested pipes to the other duct.

FIG. 85 shows the three-dimensional spiral heat exchanger with design modification at the sides of the axial tube.

FIG. 86 shows a spiral planar heat exchanger with an elongated spiral.

FIG. 88 shows the front view of a three-dimensional spiral heat exchanger with an elongated spiral.

FIG. 89 shows a perspective view of three dimensional spiral heat exchanger without the separator plate, and a three dimensional spiral heat exchanger with the separator plate.

FIG. 90 shows the spiral is divided into four unequal spiral parts in which these parts are connected by straight lines.

FIG. 91 shows a three-dimensional spiral heat exchanger with a spiral stretched in two directions.

FIG. 92 shows a section view of a three-dimensional spiral heat exchanger with a spiral extended in two directions.

FIG. 93 shows a section view of a three-dimensional spiral heat exchanger with a spiral extended in two directions.

FIG. 94 shows a section view of the three-dimensional spiral heat exchanger and the semi-oval reference geometry, in which the curve stretched in two directions.

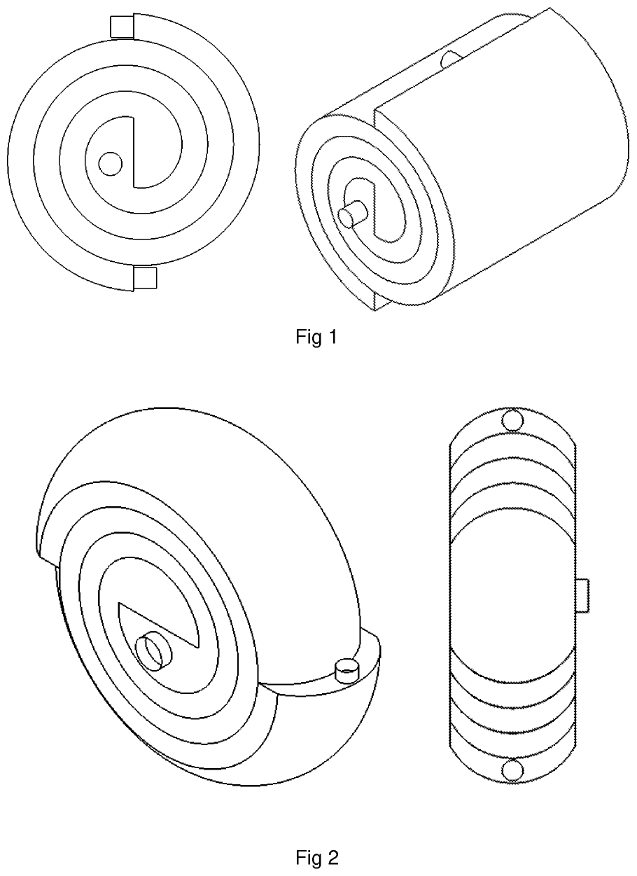

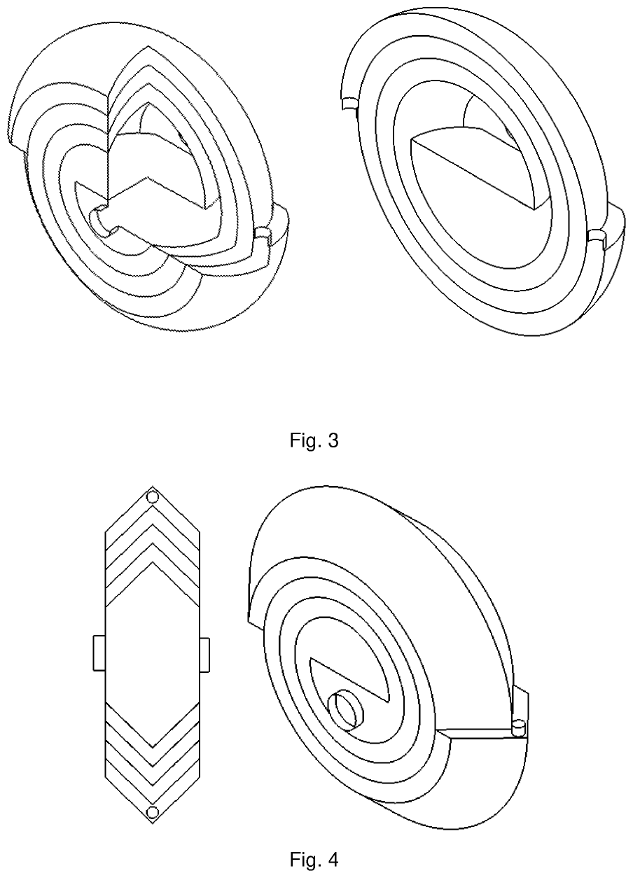

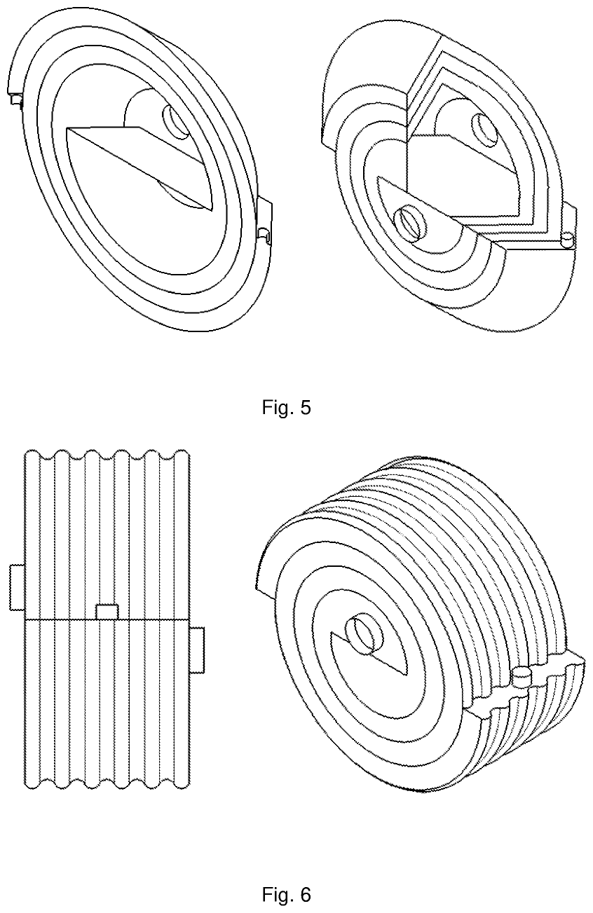

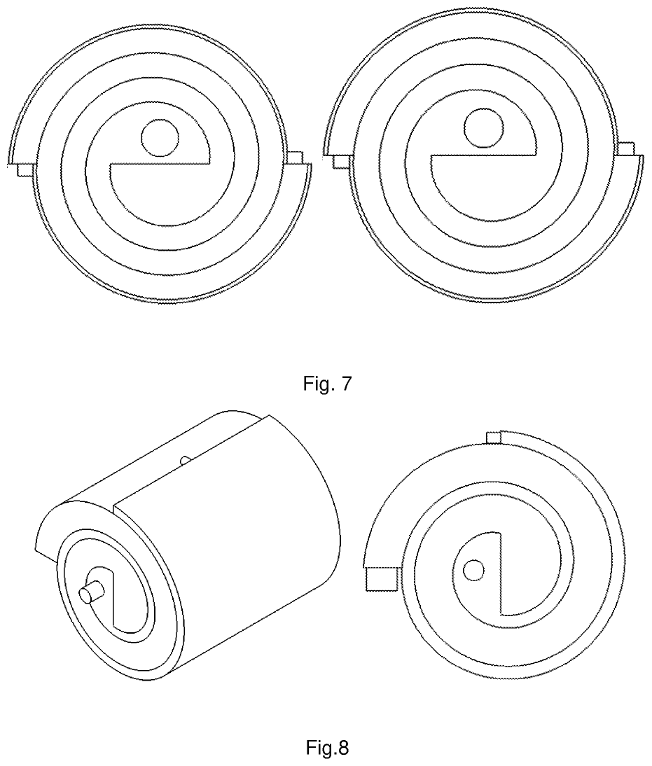

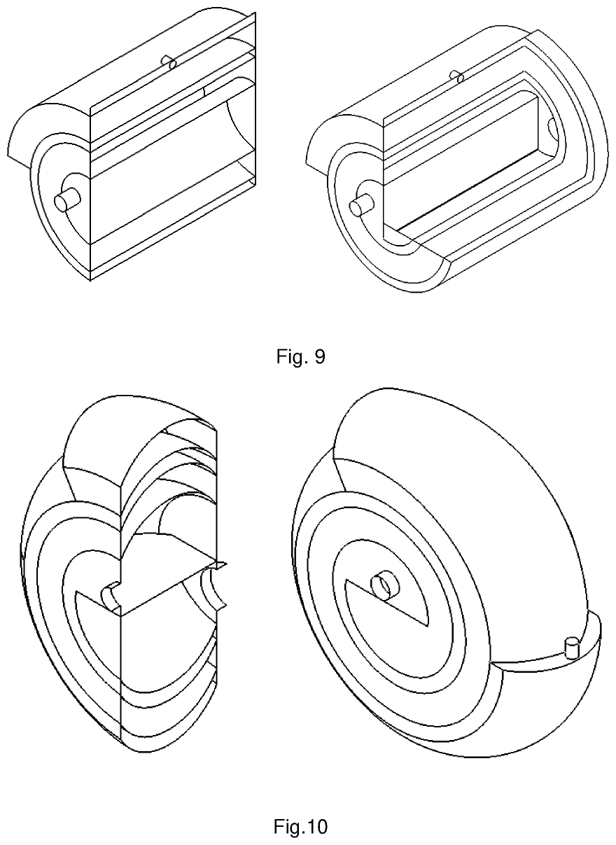

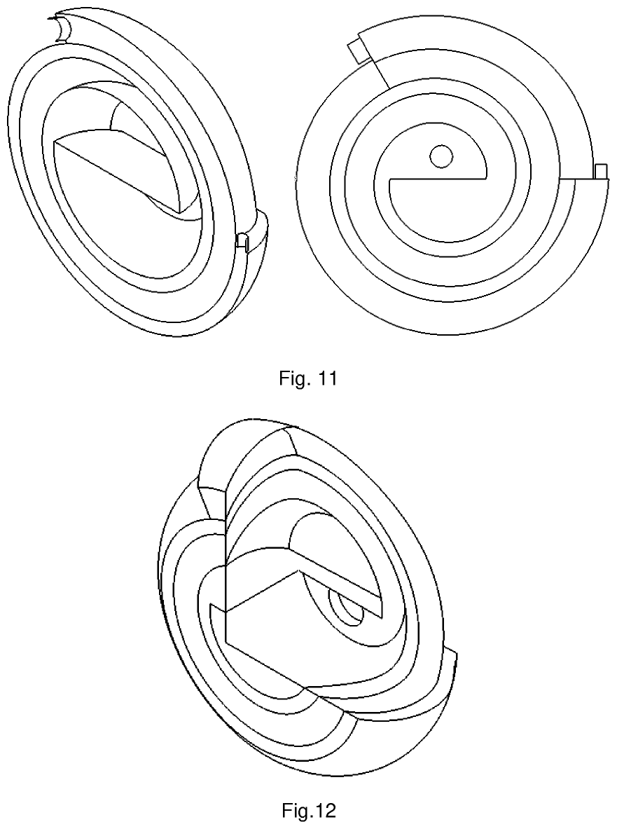

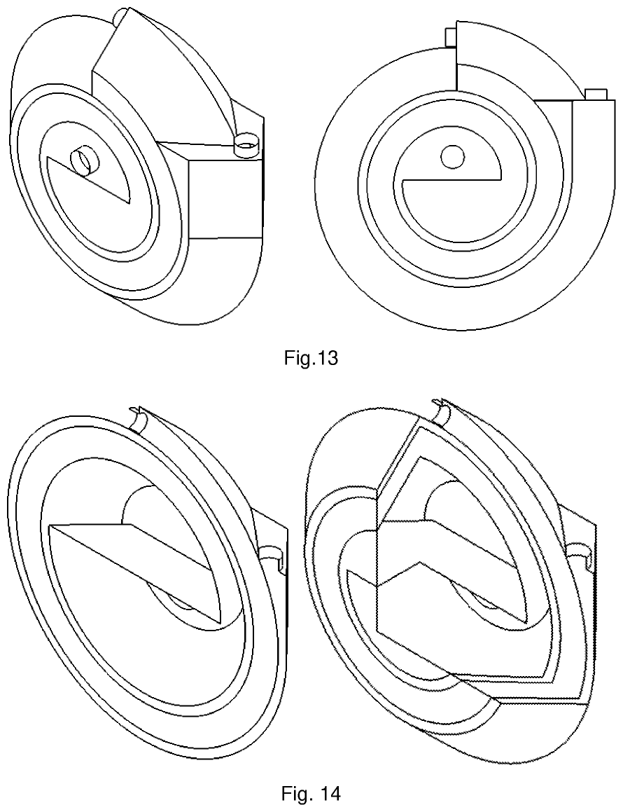

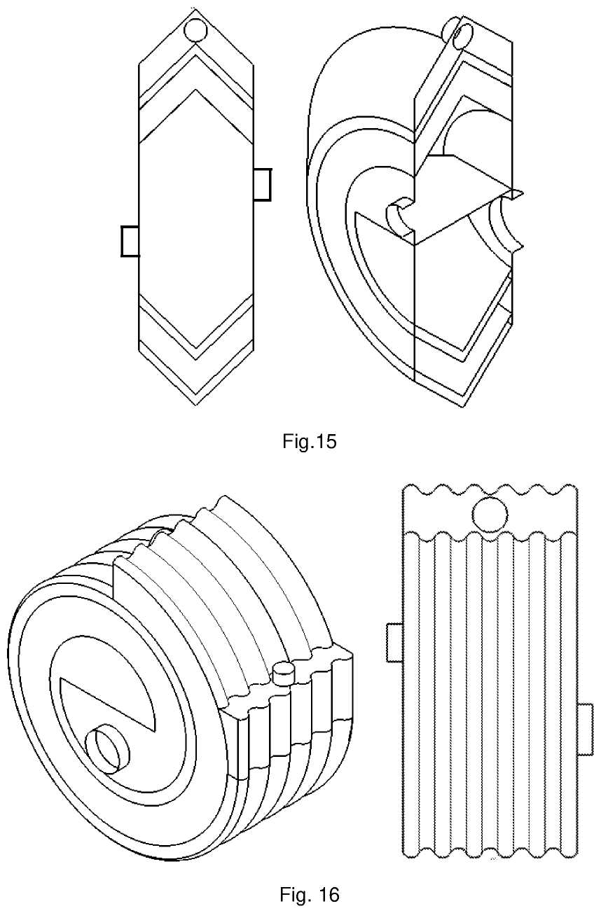

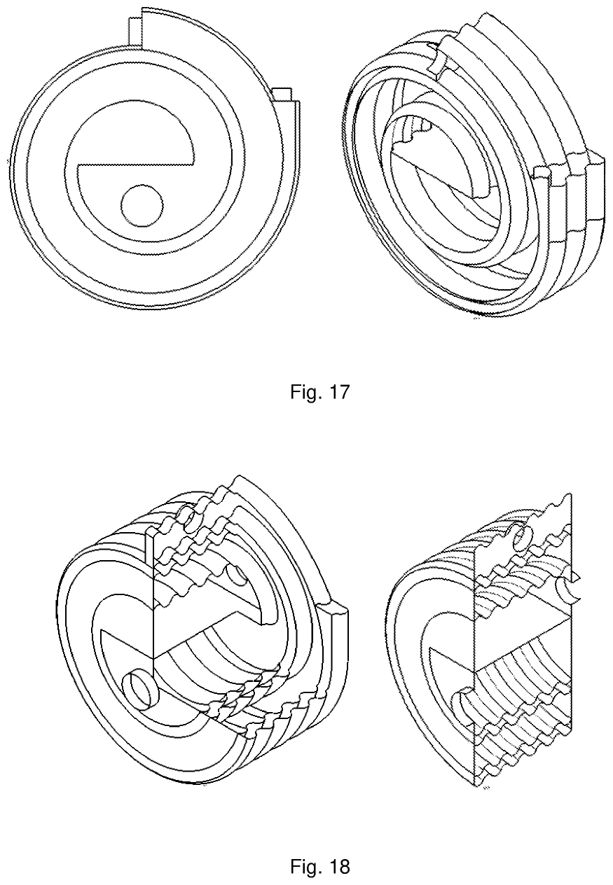

### DESCRIPTION OF EMBODIMENTS

Three-dimensional spiral shell comprising a set of nested shells surface which has spiral form in three-dimension.

In order to form a three-dimensional spiral, the two-dimensional geometry which is planar (triangle, rectangle, square, halved hexagon, semicircle, half-ellipse, half-parabolic, and any other reference geometry) scales relative to a point and thus becomes larger or smaller, simultaneously with the rotation around the axis of basic spiral.

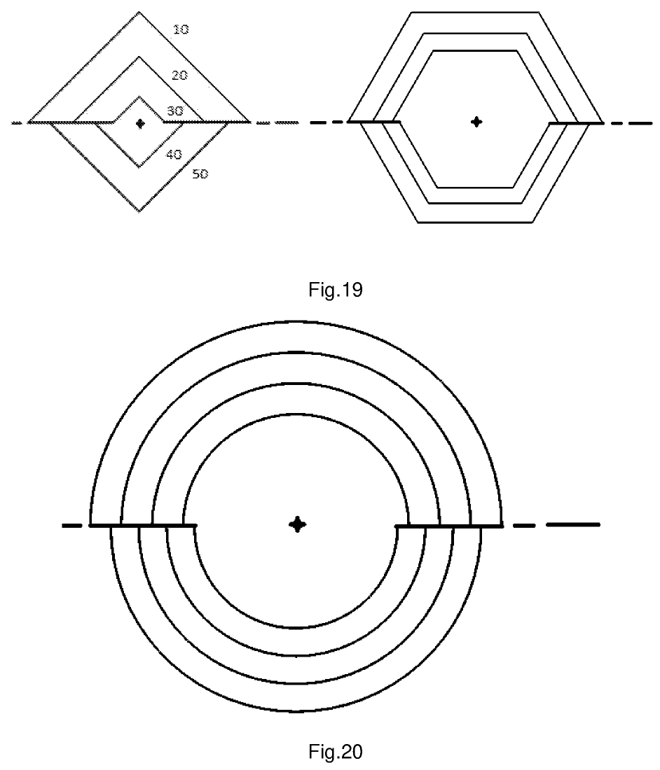

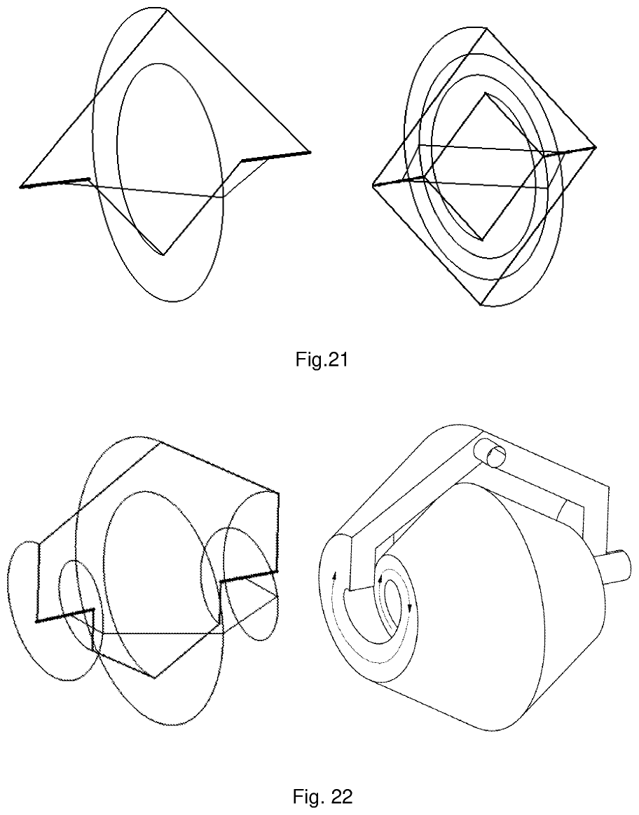

Reference geometry in a three-dimensional spiral shell:
If in a geometry where the side parallel to the axis of rotation has the shortest distance from the axis of rotation or is located on the axis of rotation; removing that side altogether will result in the formation of a reference geometry for the formation of a three-dimensional spiral shell (FIGS. 19, 20).

The three-dimensional spiral shell is defined as below:
Geometric location of the points in space that is formed by the simultaneous rotation and scale of a reference geometry. In this case, the rotation takes place around the axis of rotation (spiral axis) and scaling (shrinking or enlarging the reference geometry) is done relative to a reference point.

Scaling two-dimensional geometry around a reference point:
The distance of all points on the reference geometry from the reference point is multiplied by a constant value that leads to the formation of a new point in the same direction.

In FIG. 19, the reference geometry for forming a three-dimensional spiral shell consist of two sides of a triangle. The lower side on the rotation axis has not been shown. The horizontal dashed line shows the axis of the rotation.

Broken line (10) represents the reference (basic) geometry.

The dashed line shows reference geometries after 360 degrees of rotation and scaling around the reference point. The reference point in the figure is indicated by (+).

Two-dimensional geometry is scaled relative the reference point in each rotation, thus broken lines 20 and 30, which are at an angle of 360 and 720, are scaled relative to the base and reference point geometry simultaneously

The broken lines 40 and 50 are similar to the reference geometry and rotated 180 and 540 degrees respectively, and scaled relative to the reference point.

Since these lines are scaled in proportion to the angle of rotation and the spiral radius at the same angle, they are smaller than the original broken line (line 1).

Since these lines rotate 180 and 540 degrees relative to the original dashed line, their direction is reversed relative to the reference geometry. In FIG. 19, the reference geometry of a halved hexagon. The other steps mentioned above are repeated for the hexagonal reference geometry.

The lower side of this hexagon, which is located on the spiral axis, has removed.

The above steps are repeated for the reference geometry of the hexagon.

The scale applied to each angle of rotation is obtained using the following method:
The ratio of the spiral radius at any angle of spiral to the initial spiral radius (spiral radius at zero angle)
(The spiral radius at angles 0, 360 and 720 is in the same direction but not equal) In these images, two-dimensional geometries and a wire frame of a three-dimensional spiral shell and two nested three-dimensional spiral shells related to each of the forms are shown in FIGS. 20-23. In this heat exchanger, fluids have not any contacts and heat exchange between the two fluids takes place through the walls.

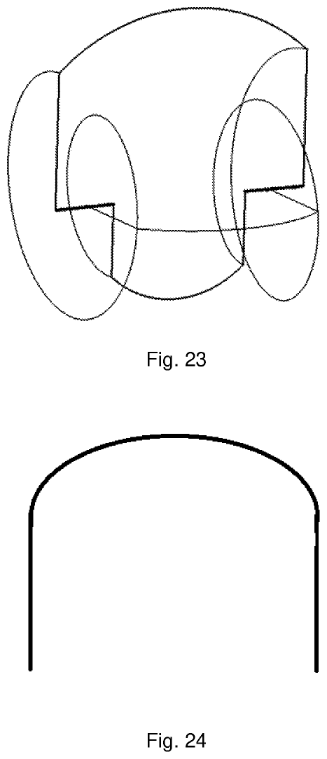

FIG. 24 shows the reference geometry that led to the creation of the three-dimensional spiral shell in FIG. 23.

If the reference geometry for forming a three-dimensional spiral shell is parabolic, it can be used to form a three-dimensional parabolic spiral heat exchanger in the following order:

Three-dimensional parabolic spiral heat exchangers are actually a type of three-dimensional spiral heat exchanger that consists of the following parts:
a) A pair of three-dimensional spiral shells nested as a wall of heat exchanger,
b) Central separator of the heat exchanger that separates the path of the two ducts completely,
c) Pipes connected to the center of the heat exchanger,
d) Pipes connected to the heat exchanger shell, in other embodiment the fluid is at the end of its path, contact directly with the medium.

Other form of three-dimensional heat exchangers (square, hexagonal, triangular, etc.) can be formed by using a pair of three-dimensional spiral shells whose reference geometry is not parabolic (triangular, hexagonal, square and other non-parabolic geometries) and placing these shells nested for the heat exchanger wall and performing other steps in the same way.

In cases where the reference geometry of the three-dimensional spiral shell is semicircular or semi-oval, it can lead to spherical and elliptical spiral shells. Which are explained as follows:
Spherical spiral heat exchanger;
Elliptical spiral heat exchanger.

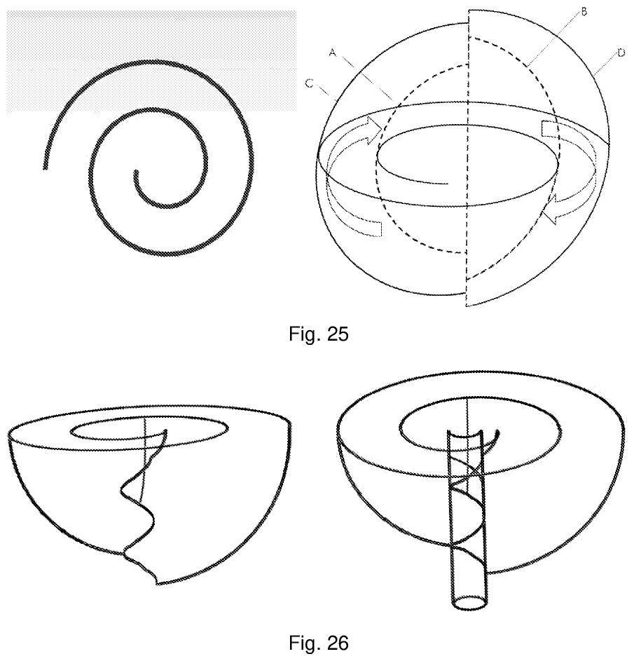

Spherical spiral heat exchanger wall:
If in a two-dimensional spiral structure (FIG. 25), for each point on the spiral, a semicircle perpendicular to the plane (the center of the semicircle is the same point as the center of the spiral) is tangent to the spiral curve so that the semicircle in Its 90 degree angle, collide with spiral curve. (FIG. 25) leads to the formation of a shell called a spherical spiral shell (FIG. 26). in such way, the two nested spherical walls form the spherical spiral heat exchanger which the radius of the spheres gradually becomes larger which makes three-dimensional spirals.

These heat exchangers can be designed in such a way that the volumes of both heat exchanger ducts are equal or vice versa.

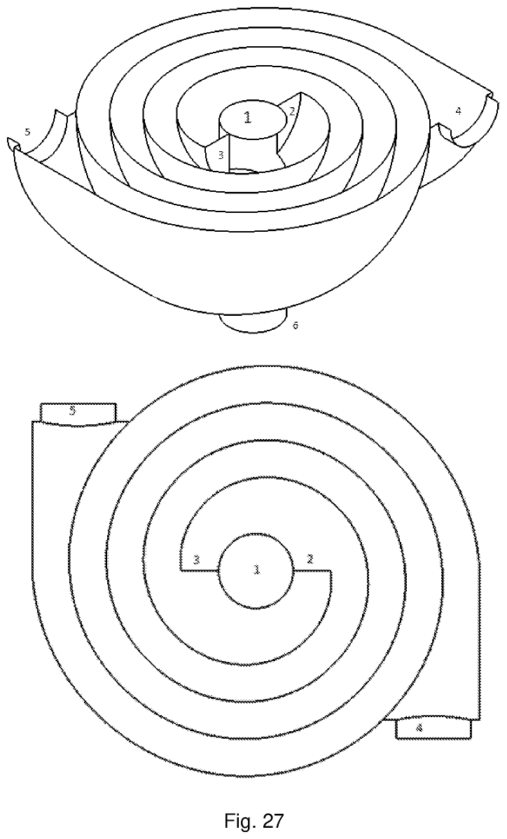

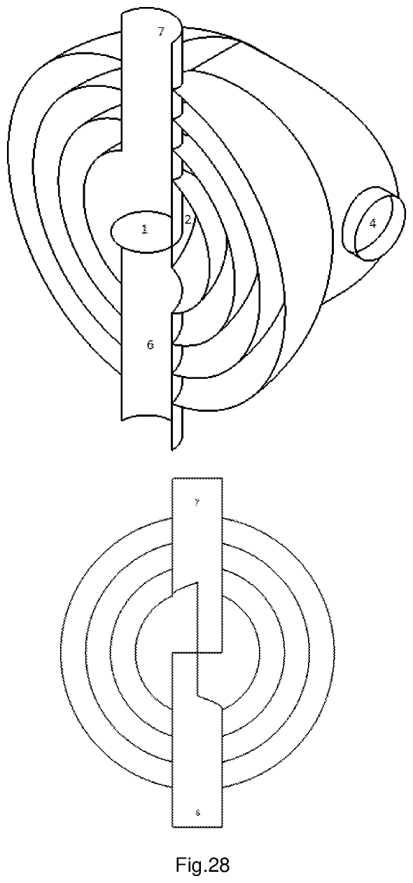

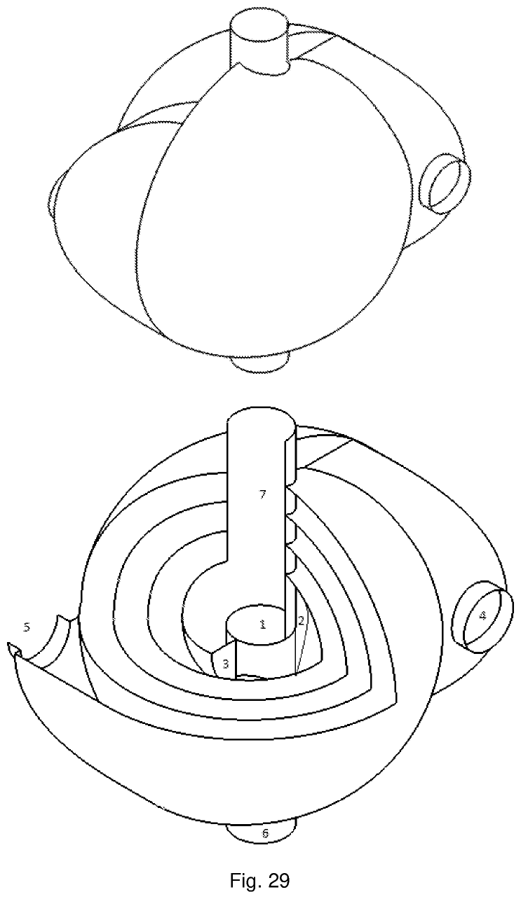

The center of the spherical spiral heat exchanger can be divided into two parts by using a curved or angled sheet or several sheets connected to each other in such a way to create two completely separate paths. In FIG. 27, the axial tube is cut in such a way that its lower part is connected to the center of the first duct and its upper part is connected to the second duct. In addition, plates 1, 2 and 3 completely separate the two ducts so that fluid mixing does not occur. (Parts 1, 2 and 3 in FIGS. 27 and 28)

Each duct has at least one inlet and at least one outlet, one of which is located in the center of the heat exchanger and the other is located on the shell.

The tube connected to the center of each duct is connected directly to the outside of the sphere. (FIG. 28)

Tubes 4 and 6 are connected to the first duct, where tube 4 is connected to the outer shell of this duct and tube 6 is connected to the center of the duct. Tubes 5 and 7 are connected to the second duct, where tube 5 is connected to the outer shell and tube 7 to the center of the same duct.

Tube 4 is connected to the outer shell of the first duct and tube 6 is connected to the center of this duct. Tube 5 is connected to the outer shell of the second duct and tube 7 is connected to the center of this duct.

The separator sheet consists of parts 1, 2 and 3 of the heat exchanger center.

This part can also be designed as a curve.

In a heat exchanger, plates 1, 2, and 3 are actually separator plates that prevent the two fluids from mixing together.

In the said heat exchanger, for each of the two main ducts, there is an inlet or outlet in the center of the sphere and an inlet or outlet on the outer shell. By entering one of the two paths, the hot fluid comes into contact with the walls, which are in contact with the cold fluid from the other side. Therefore, without fluid mixing, the heat of the hot fluid can be transferred to the cold fluid through the walls.

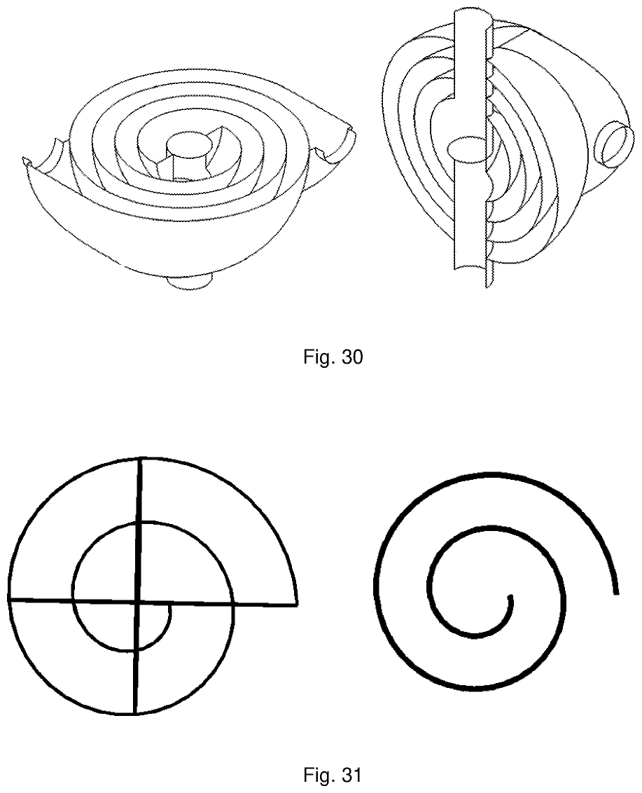

In each of the paths, the cross-sectional area of the duct through which the flow passes decreases as the fluid moves from the outer shell to the center of the sphere. FIG. 30 shows the path of two fluids in the heat exchanger.

For more efficiency, two streams with opposite directions can also be used, so that the inlet of one fluid in the first path is from the center of the sphere and the inlet of the other fluid in the other channel is from the shell of the sphere.

In each of the paths, the cross-sectional area of the duct through which the flow passes increases as the fluid moves from the center of the sphere to the outer shell. Therefore, the velocity decreases as the fluid moves from the center of the sphere to the outlet on the shell. The spherical structure of the heat exchanger makes it able to withstand high pressures and is suitable for cooling pressurized gases or converting gases to liquids.

Three-dimensional elliptical spiral heat exchangers are divided into the following two categories:
Lenticular spiral heat exchanger;
Oval spiral heat exchanger.

In addition to the physical properties, the built-in space for heat exchangers in thermal cycles also justifies the construction of heat exchangers in various geometries.

Lenticular spiral heat exchanger:
If the tangential point of the spiral is on a large oval diameter, the resulting shell will be a lenticular shell as shown in FIGS. 31 & 32.

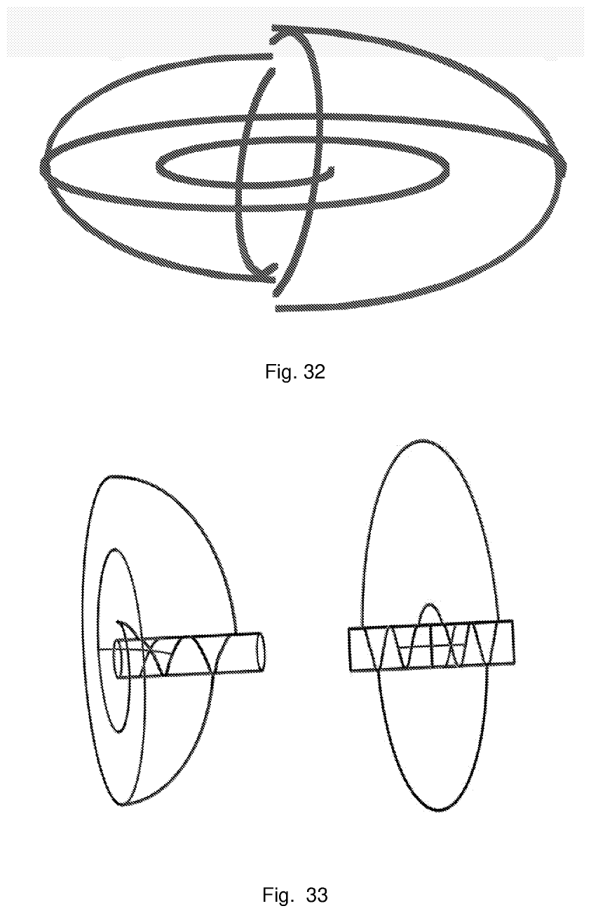

FIG. 31 shows the left side of the spiral heat exchanger and FIG. 32 shows the spiral and semi-tangential ellipses on it.

In this type of heat exchanger, the center of the sphere can be similarly divided into two parts by using a sectioned sheet or a sectioned pipe.

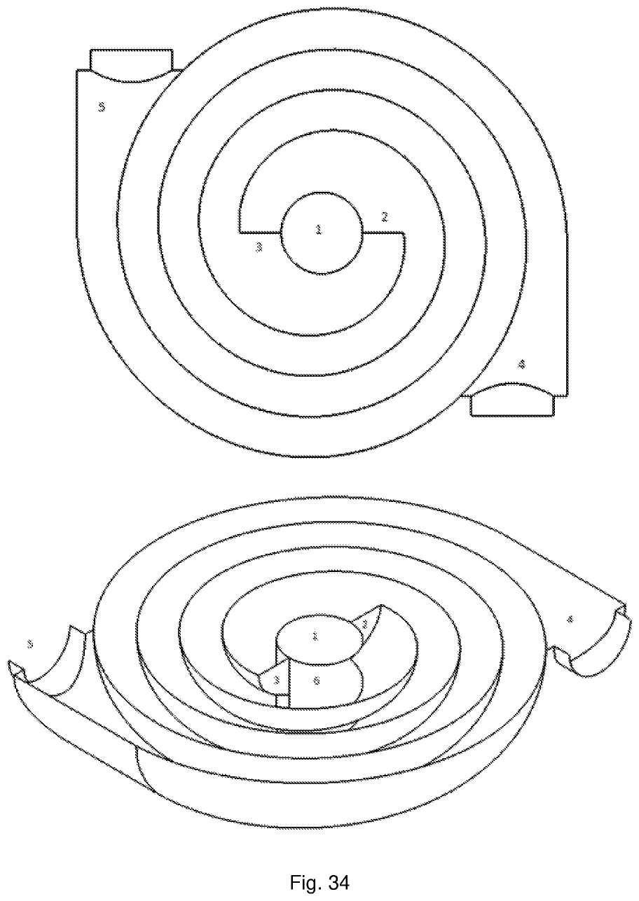

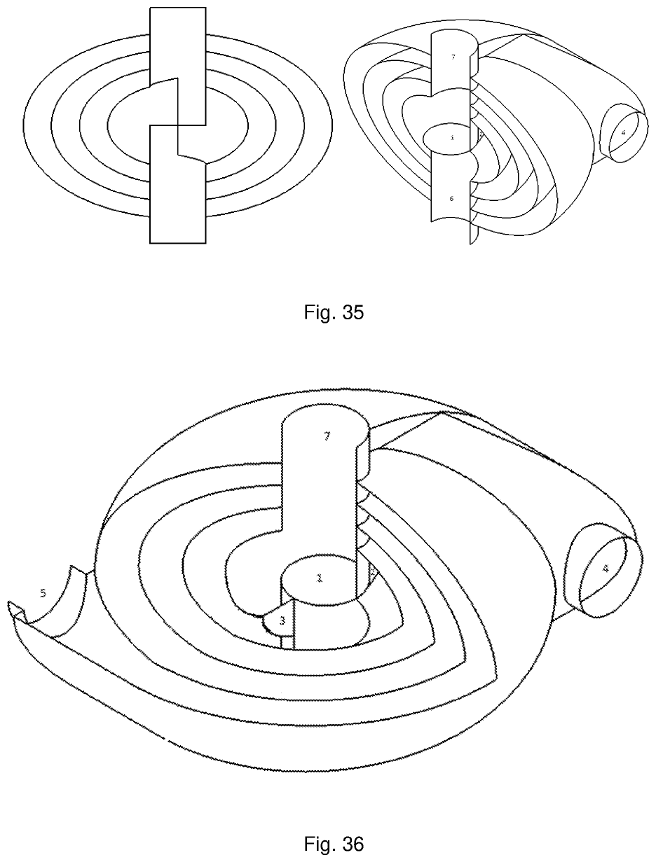

Oval spiral heat exchanger:
If the point tangent to the spiral (FIGS. 32 & 33) is on the smaller diameter of the ellipse, it will result in an oval spiral. (FIGS. 34 & 35)

Oval spiral heat exchanger consists of at least two nested oval spiral shells, in which pipes connected to the beginning and end of each duct and separator located in the center of the heat exchanger.

Similarly, parabolic spiral shells whose reference geometry is a parabolic other than a semicircle or a semicircle are formed in the same way, which can similarly be used to form a parabolic spiral heat exchanger wall.

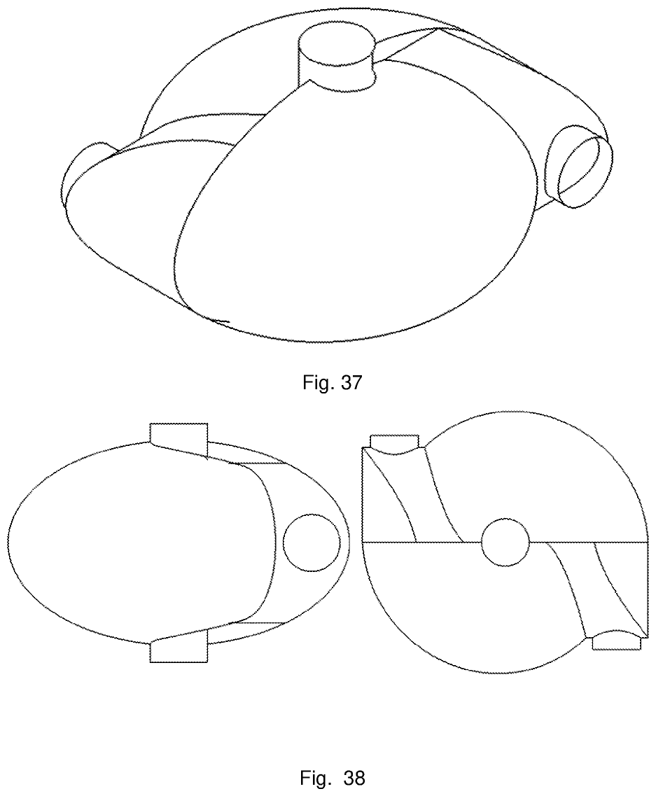

As shown in FIGS. 36, 37 and 38, tubes 4 and 6 are connected to the first duct, in which tube 4 is connected to the outer shell of this duct and tube 6 is connected to the center of the duct. Tubes 5 and 7 are connected to the second duct, where tube 5 is connected to the outer shell and tube 7 is connected to the center of this duct.

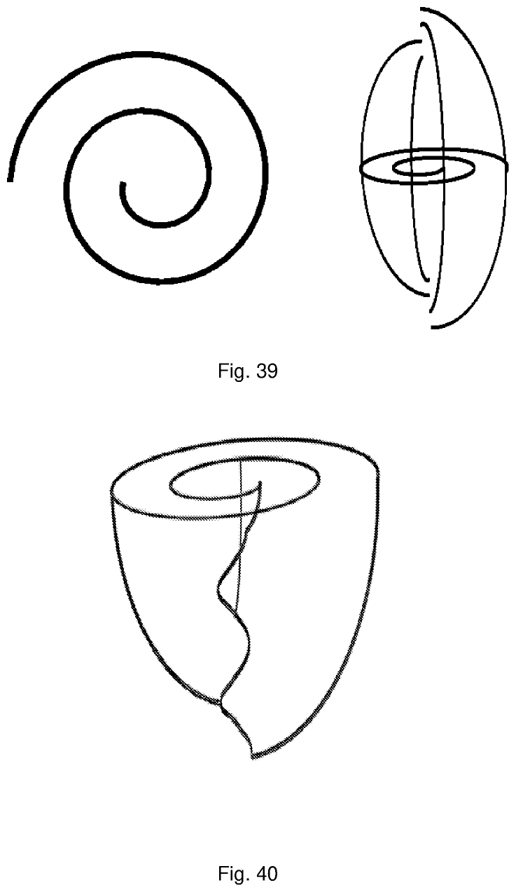

If the point tangent to the spiral (FIG. 39) is on a smaller diameter ellipse (half of the cut ellipse), it will result in an oval spiral. (FIGS. 39 and 40)

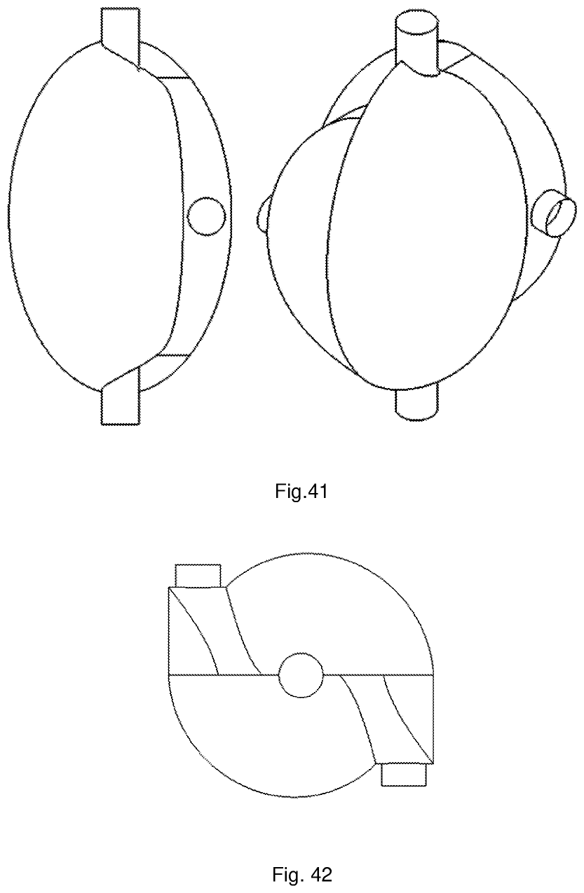

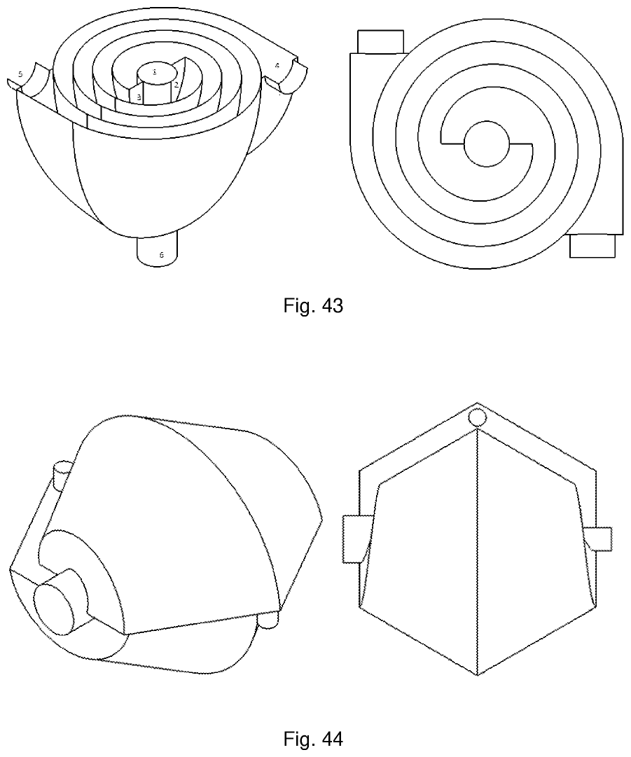

Oval spiral heat exchange consists of two nested spiral shells, tubes connected to the beginning and end of each duct and separator located in the center of the heat exchanger (FIGS. 41, 42 and 43). Tubes 4 and 6 are connected to the first duct, where tube 4 is connected to the outer shell of this duct and tube 6 is connected to the center of the duct. Tube 5 is connected to the second duct and an axial tube is connected to the center of this duct from above. In this type of heat exchanger, the center of the heat exchanger can be similarly divided into two parts by using a cut pipe and a sheet (Plates 1, 2 and 3).

Combined spiral heat exchanger can also be designed using broken, curved and distorted lines.

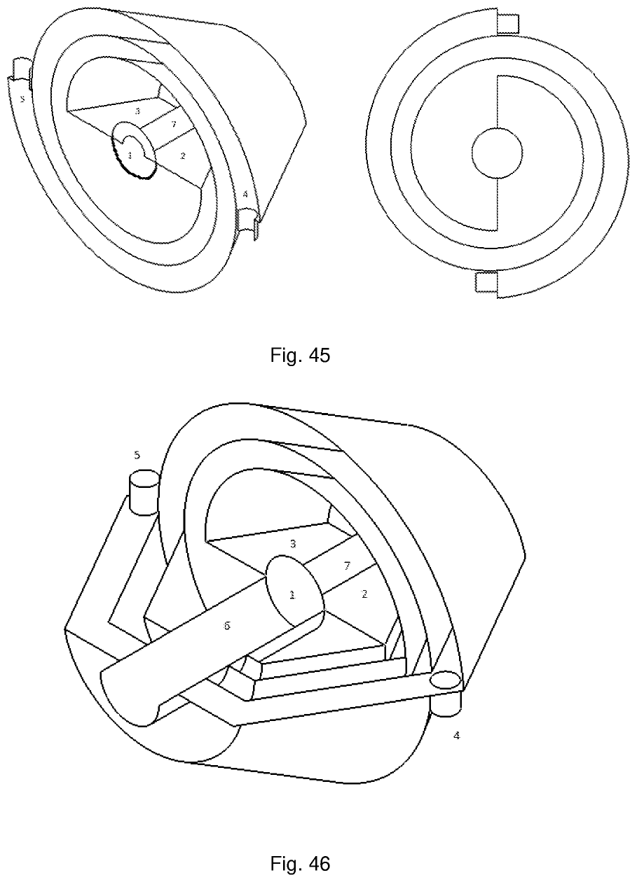

Axial pipes can also be used with different diameters so that the diameters of the two axial pipes are not equal (FIGS. 44, 45 and 46). Tubes 4 and 6 are connected to the first duct, where tube 4 is connected to the outer shell of this duct and tube 6 is connected to the center of the duct. Tubes 5 and 7 are connected to the second duct, with tube 5 being connected to the outer shell and tube 7 to the center of the same duct. In this type of heat exchanger, the center of the heat exchanger can be divided into two parts by cutting pipes and separator plates. In the FIG. 46, plates 1, 2 and 3 are separator plates that prevent the two fluids from mixing together. In the central shell of the first duct, the upper half of tube 6 is cut, and in the central shell of the second duct, the lower half of tube 7 is cut. The cut sides of both pipes with plates 2 and 3 continue to the inner wall of the shell.

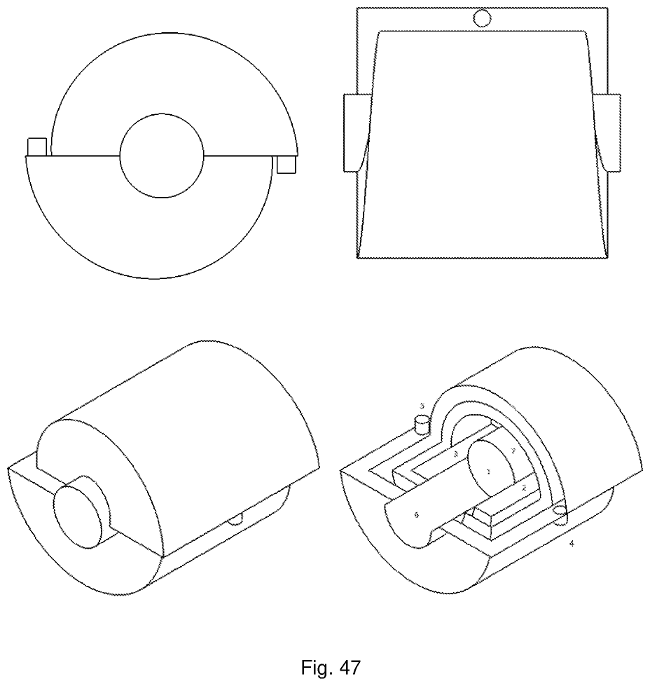

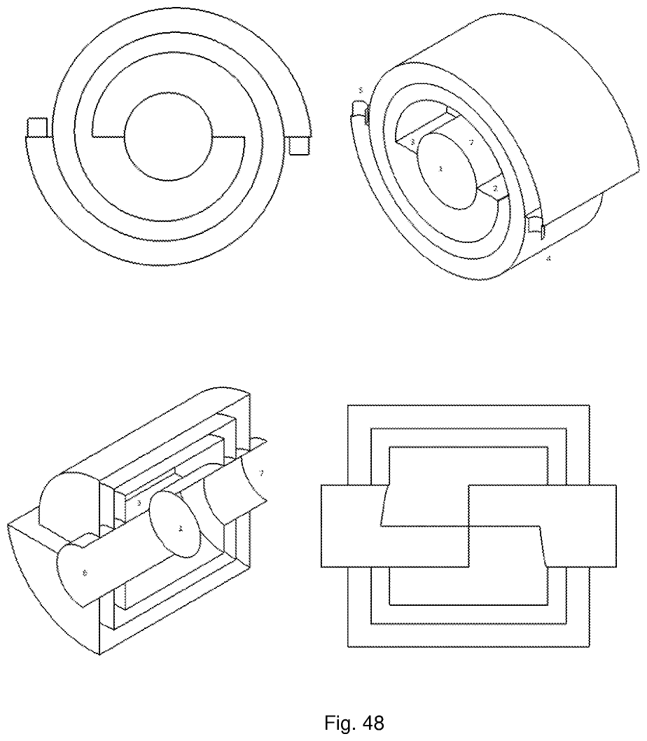

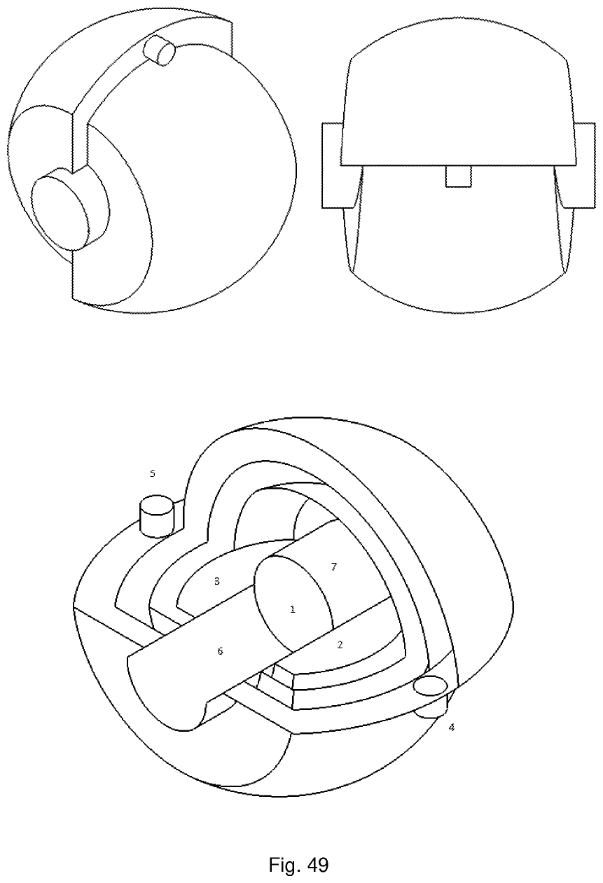

FIG. 47 shows a spiral three-dimensional heat exchanger whose reference geometry is rectangular. FIG. 48 shows a section view of a three-dimensional spiral heat exchanger whose reference geometry is rectangular.

Tubes 4 and 6 are connected to the first duct, where tube 4 is connected to the outer shell of this duct and tube 6 is connected to the center of the duct. Tubes 5 and 7 are connected to the second duct, where tube 5 is connected to the outer shell and tube 7 is connected to the center of this duct.

In the FIGS. 47 & 48, plates 1, 2 and 3 are separator plates which prevent the two fluids from mixing together. In the central shell of the first duct, the upper half of tube 6 is cut, and in the central shell of the second duct, the lower half of tube 7 is cut. The cut sides of both tubes extend through plates 2 and 3 to the inner wall of the shell.

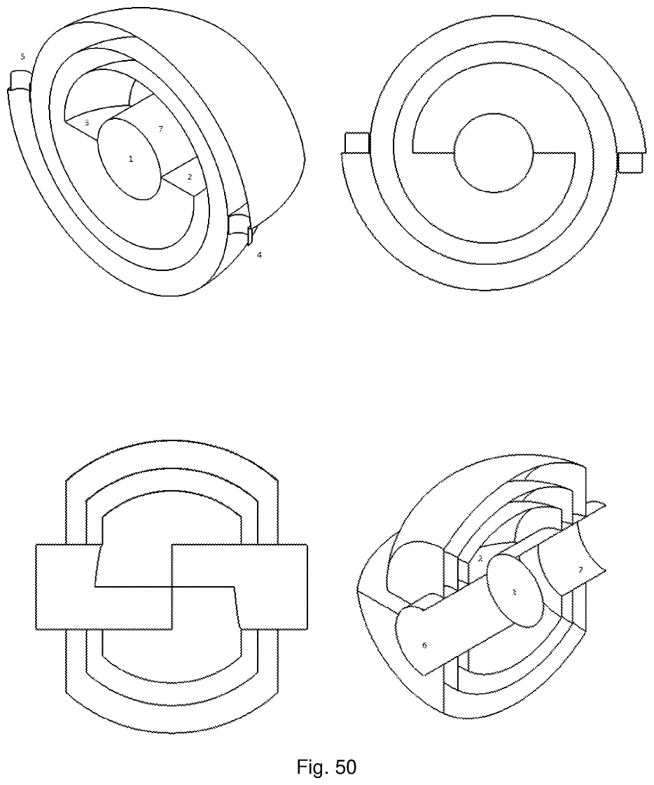

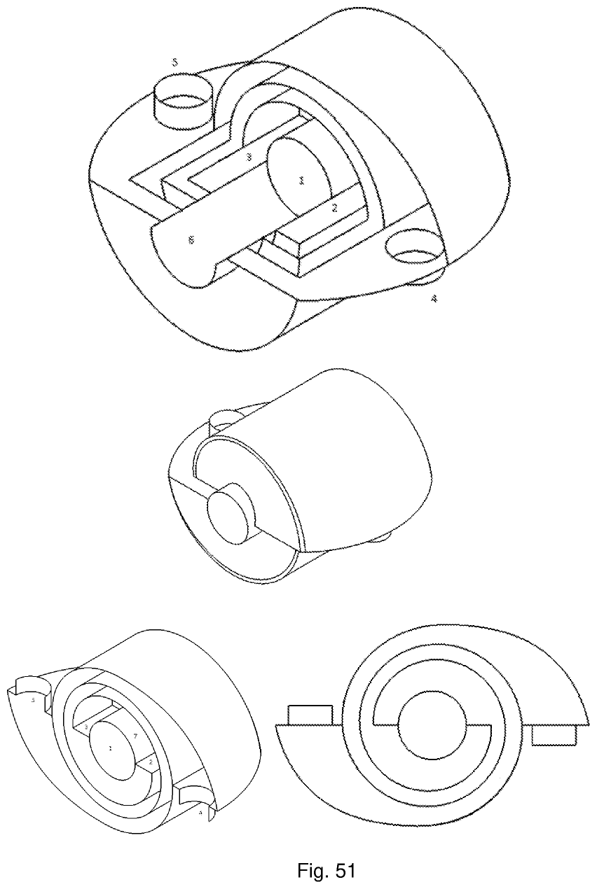

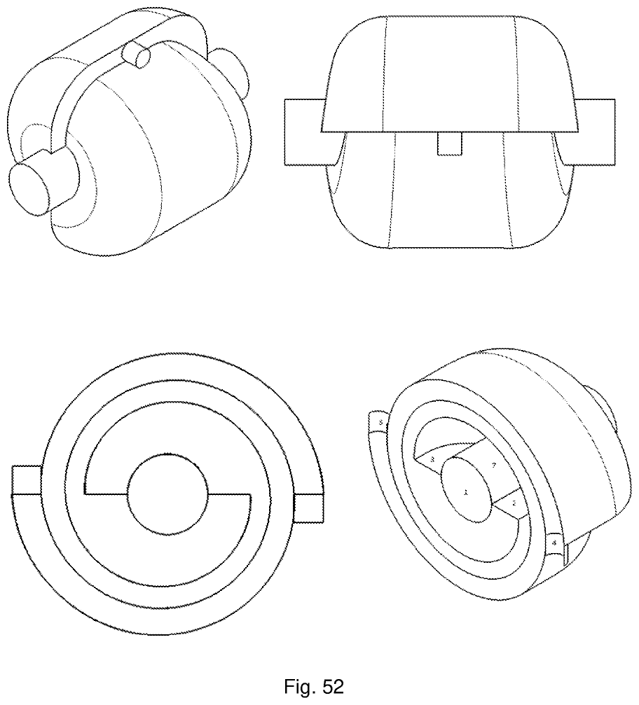

The spiral heat exchanger can be designed from a reference geometry in which straight and curved lines are used in combination. (FIGS. 49 and 50). Tubes 4 and 6 are connected to the first duct, where tube 4 is connected to the outer shell of this duct and tube 6 is connected to the center of the duct. Tubes 5 and 7 are connected to the second duct, where tube 5 is connected to the outer shell and tube 7 is connected to the center of this duct. In the FIG. 50, plates 1, 2 and 3 are separator plates that prevent the two fluids from mixing together. In the central shell of the first duct, the upper half of the tube 6 is cut and in the central shell of the second duct, the lower half of the tube 7 is cut, the cut sides of both tubes continue with plates 2 and 3 to the inner wall of the shell.

The spiral heat exchanger can be constructed in such a way that the reference geometry deforms simultaneously with the rotation around the axis as shown in FIG. 51. Tubes 4 and 6 are connected to the first duct, where tube 4 is connected to the outer shell of this duct and tube 6 is connected to the center of the duct. Tubes 5 and 7 are connected to the second duct, where tube 5 is connected to the outer shell and tube 7 is connected to the center of this duct. The plates 1, 2 and 3 are separator plates that prevent the two fluids from mixing together. In the central shell of the first duct, the upper half of the tube 6 is cut and in the central shell of the second duct, the lower half of the tube 7 is cut, the cut sides of both tubes continue with plates 2 and 3 to the inner wall of the shell.

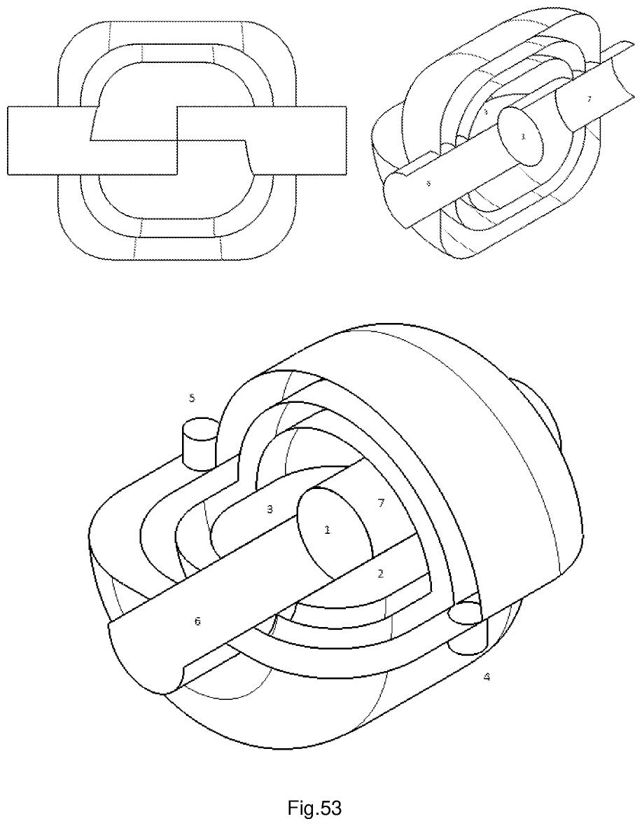

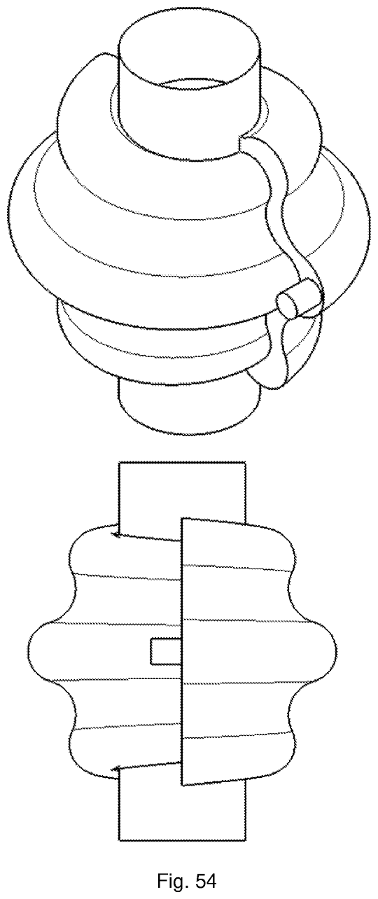

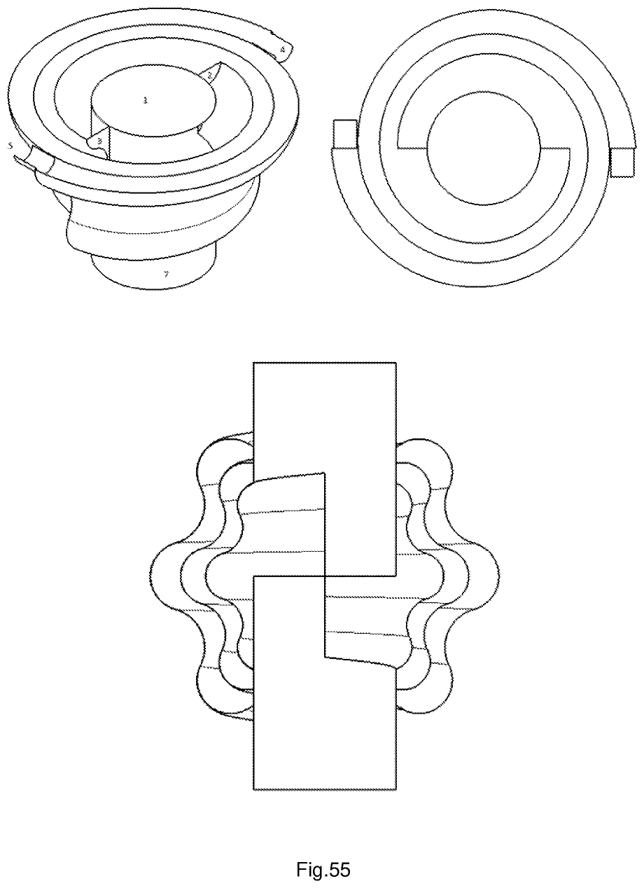

straight and curved lines can be used in such a way that no sharp angles are created in the outer shell as shown in the FIG. 53. Tubes 4 and 6 are connected to the first duct, where tube 4 is connected to the outer shell of this duct and tube 6 is connected to the center of the duct. Tubes 5 and 7 are connected to the second duct, where tube 5 is connected to the outer shell and tube 7 is connected to the center of this duct. In the picture, plates 1, 2 and 3 are separator plates that prevent the two fluids from mixing together. In the central shell of the first duct, the upper half of the tube 6 is cut, and in the central shell of the second duct, the lower half of the tube 7 is cut. The cut sides of both tubes continue with plates 2 and 3 to the inner wall of the shell.

Three-dimensional spiral shell, can be designed in a corrugated form as seen in FIG. 54. In this case, the reference geometry must have contour lines.

In all three-dimensional spiral heat exchangers, nested shells can be placed in such a way as to create two unequal ducts with different vo0lume.

To create heat exchangers where the volume of the ducts is equal, the second shell must be placed with a phase difference of 180 degrees, relative to the axis that is perpendicular to the coil plate and passes through the center of the coil.

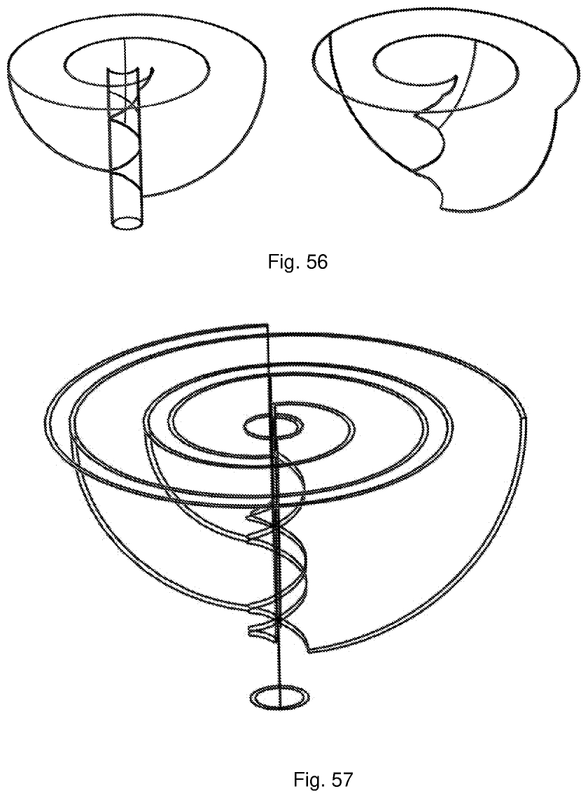

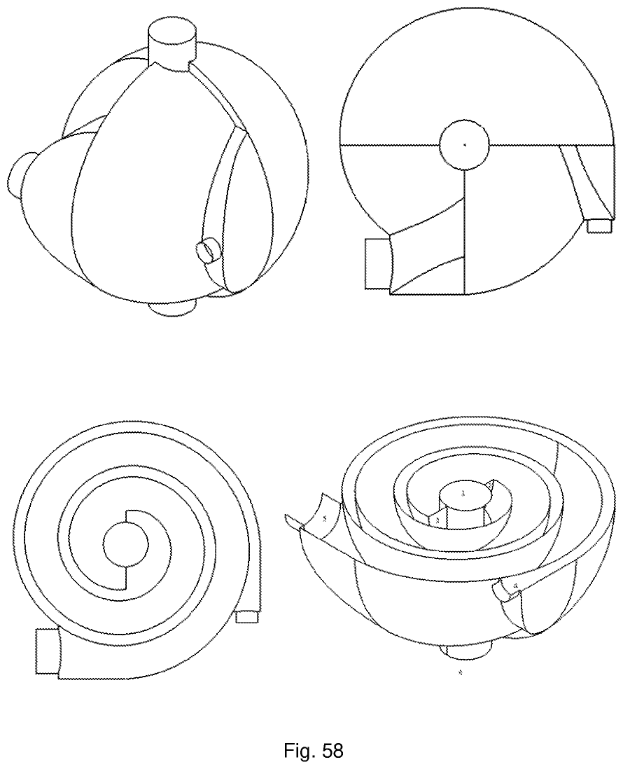

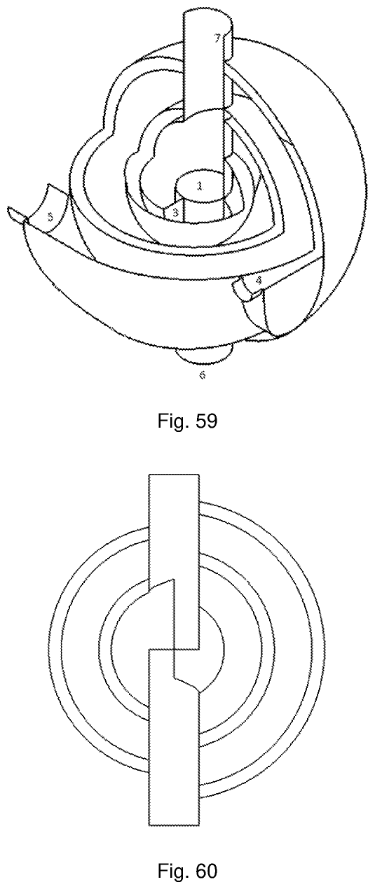

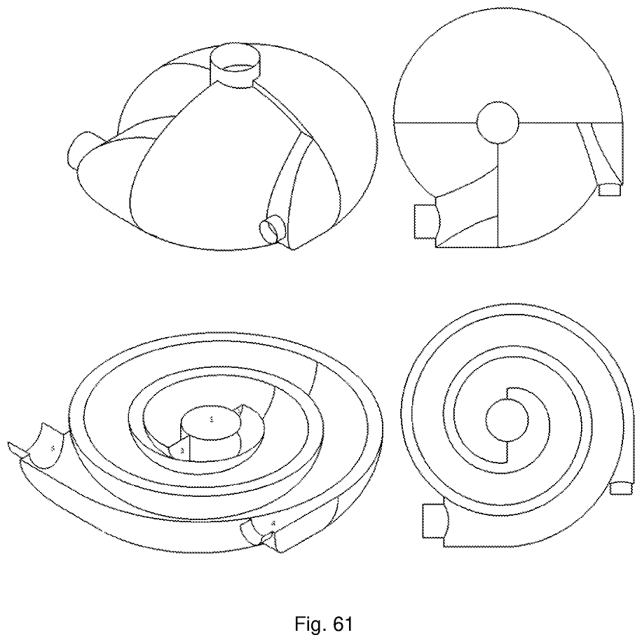

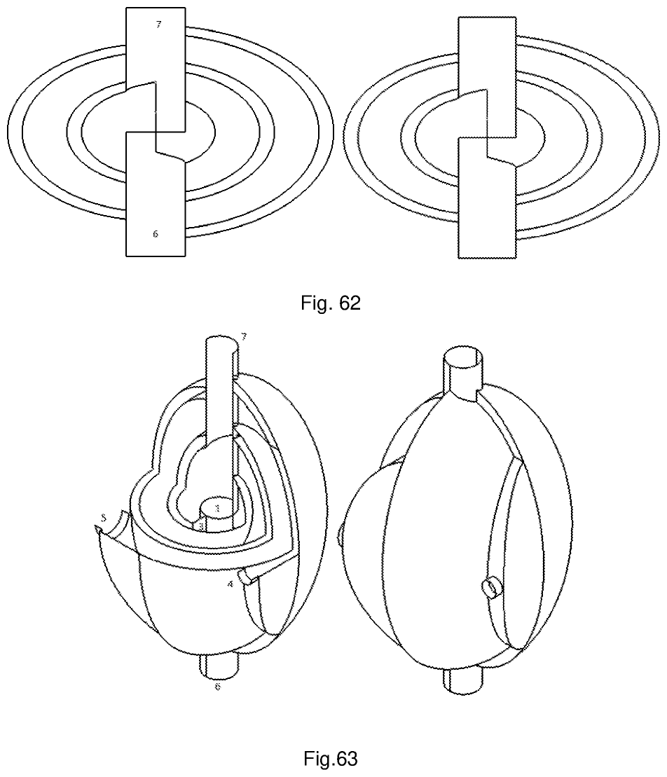

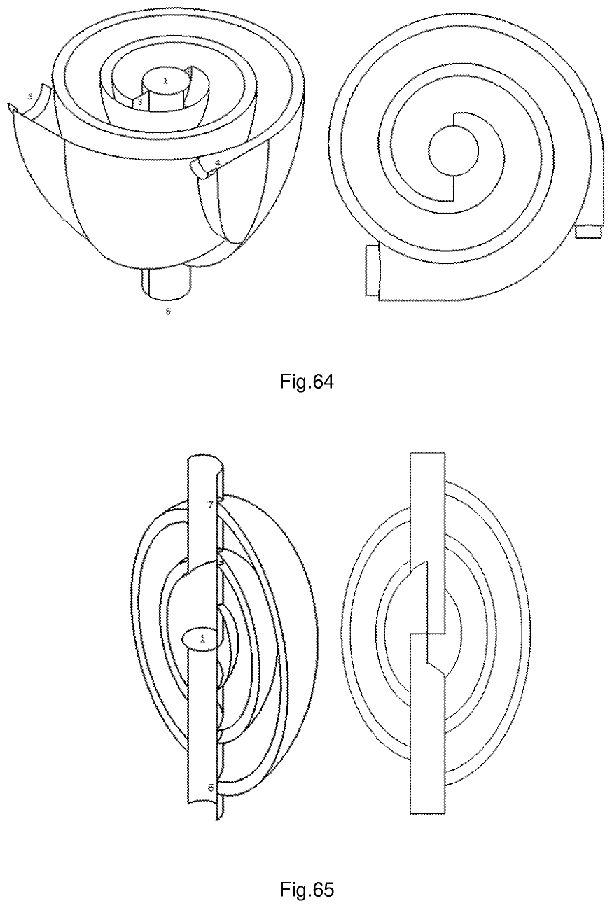

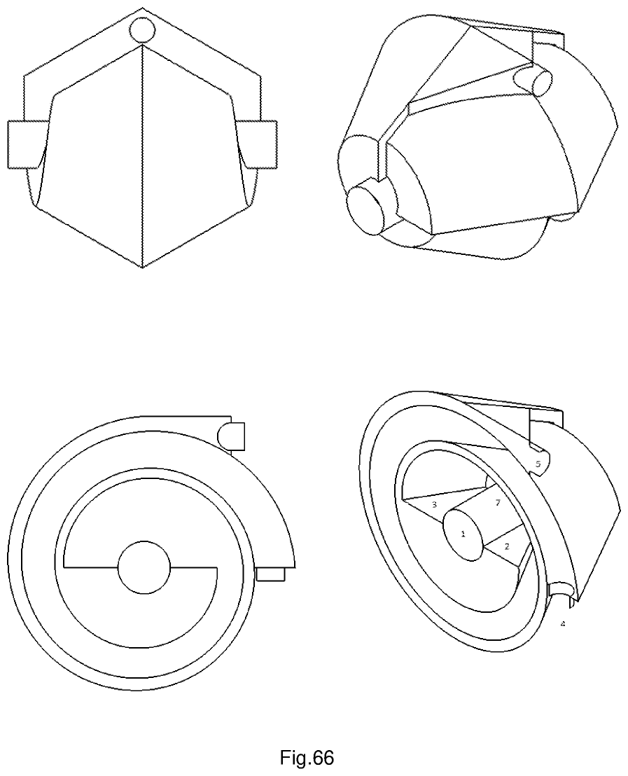

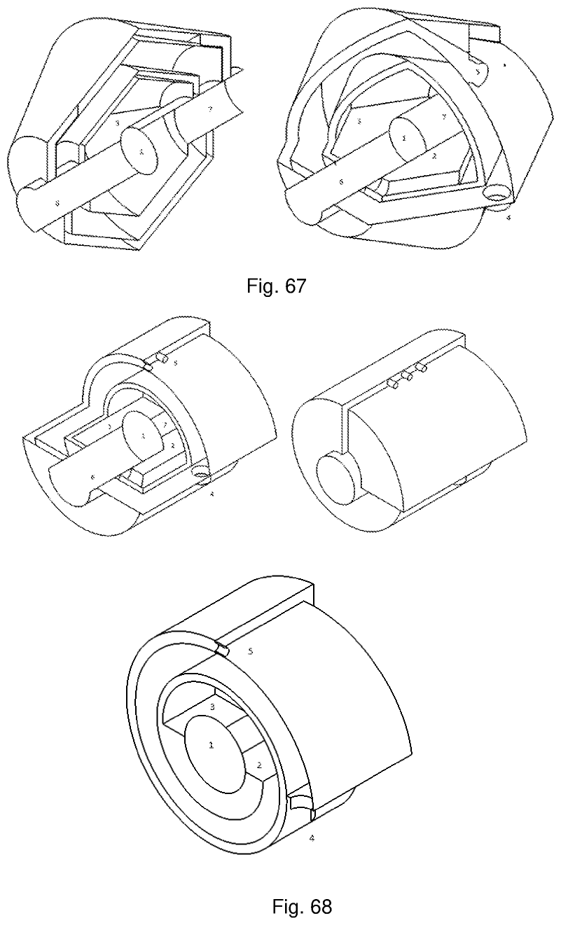

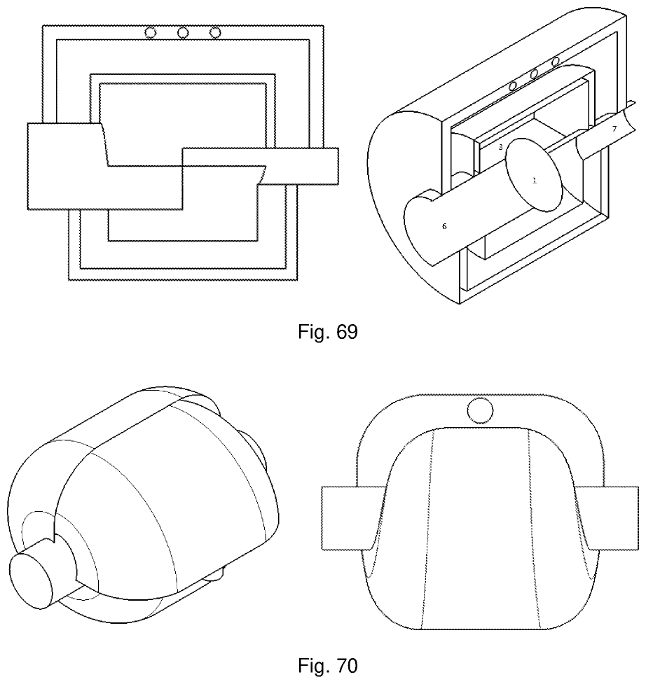

In order to create heat exchangers with ducts that do not have equal volume (unequal and unequal), the second spiral shell, which is similar to the first spiral shell, must be placed with a phase difference other than 180 degrees compared to the first shell. Then the inner or outer layers can be cut or added as needed (FIG. 57).

Tubes 4 and 6 are connected to the first duct, where tube 4 is connected to the outer shell of this duct and tube 6 is connected to the center of the duct. Tubes 5 and 7 are connected to the second duct, where tube 5 is connected to the outer shell and tube 7 is connected to the center of this duct. In the pictures, plates 1, 2 and 3 are separator plates that prevent the two fluids from mixing together. In the central shell of the first duct, the front half of the tube 6 is cut and in the central shell of the second duct, the posterior half of the tube 7 is cut, the cut sides of both tubes continue with plates 2 and 3 to the inner wall of the shell.

Similarly, in other heat exchangers, the parabolic three-dimensional spiral (lens ellipse, oval ellipse) and three-dimensional spiral with broken or corrugate lines can use the phase difference method other than 180 degrees to create two ducts with different volumes. Three-dimensional lenticular (concave) heat exchanger with two unequal duct volumes is shown in FIGS. 61 and 62.

Similarly, parabolic spiral shells whose reference geometry is a parabolic other than a semicircle or a semicircle are formed in the same way that they can be used to form a parabolic spiral heat exchanger wall of unequal volume.

Using three-dimensional spiral shells whose reference geometry is not parabolic (triangular, hexagonal, square and other non-parabolic geometries) and placing these shells nested for the wall of the heat exchanger and performing other steps in the same way. With the previous methods, three-dimensional heat exchangers (square, hexagonal, triangular, etc.) can also be formed.

In the spiral heat exchangers, it is not necessary that both axial pipes have the same diameter. It is also possible to use several tubes on the heat exchanger shell for each duct.

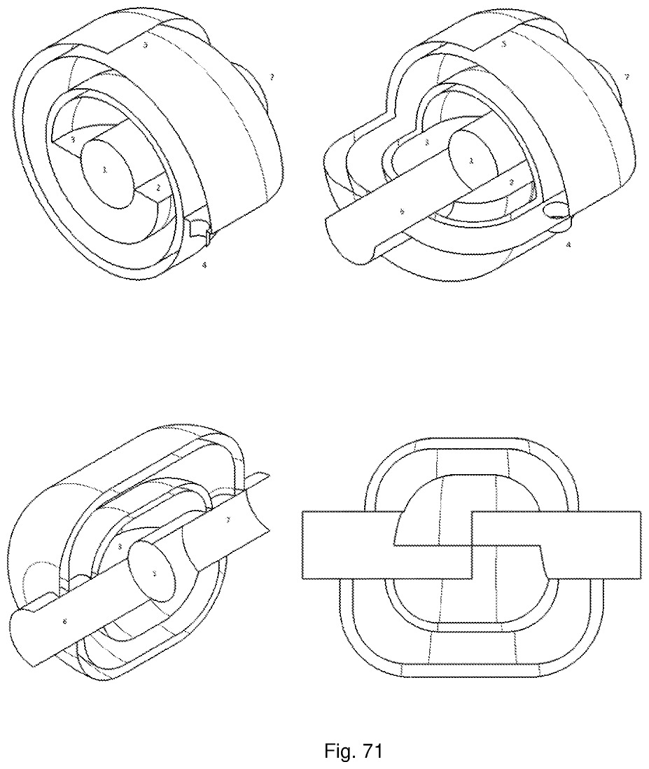

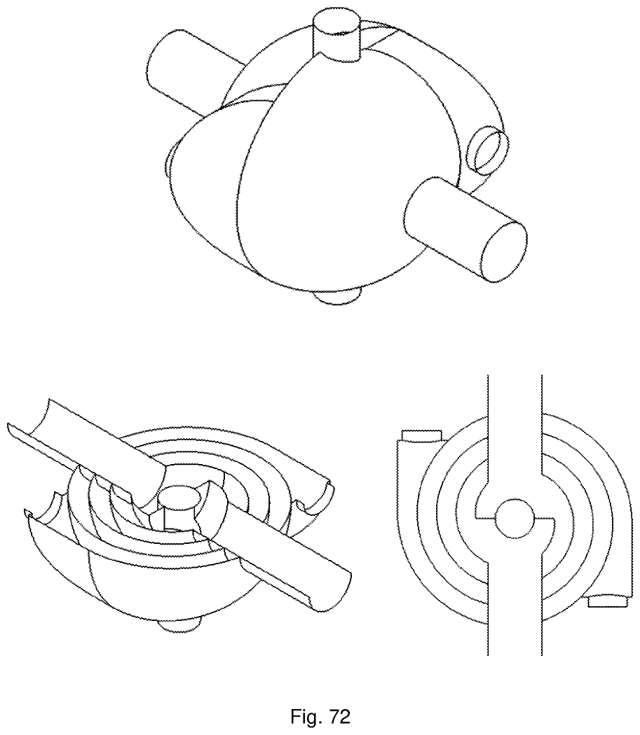

As shown in FIGS. 70 & 71, instead of a tube that connects to the shell, the end of the duct that connects to the shell can be left open to be in direct contact with the ambient fluid (In air or under water or fluid chambers).

The heat exchanger can also be designed in such a way that its larger duct exchanges fluid directly with the environment or it can be designed in such a way that both ducts exchange fluid directly with different environments (The open duct is in contact with the indoor air and the other open duct is in contact with the outside air to recycle some of the thermal energy before leaving the ventilation.)

Other central pipes can also be connected to the center of the heat exchanger, the direction of which cannot be parallel to the central pipes. (FIG. 72)

The purpose is to transfer the fluid from the center of the heat exchanger to the outside of the heat exchanger or from the outside of the heat exchanger to its center using a tube.

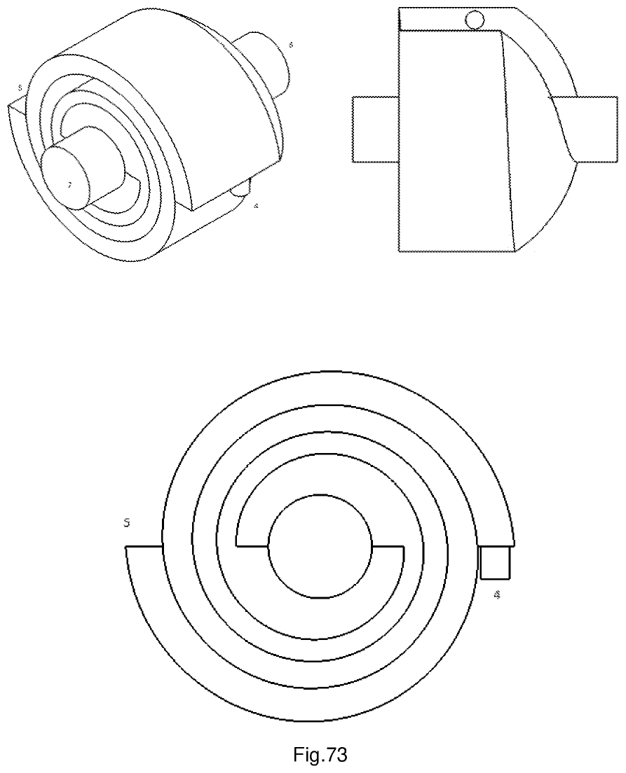

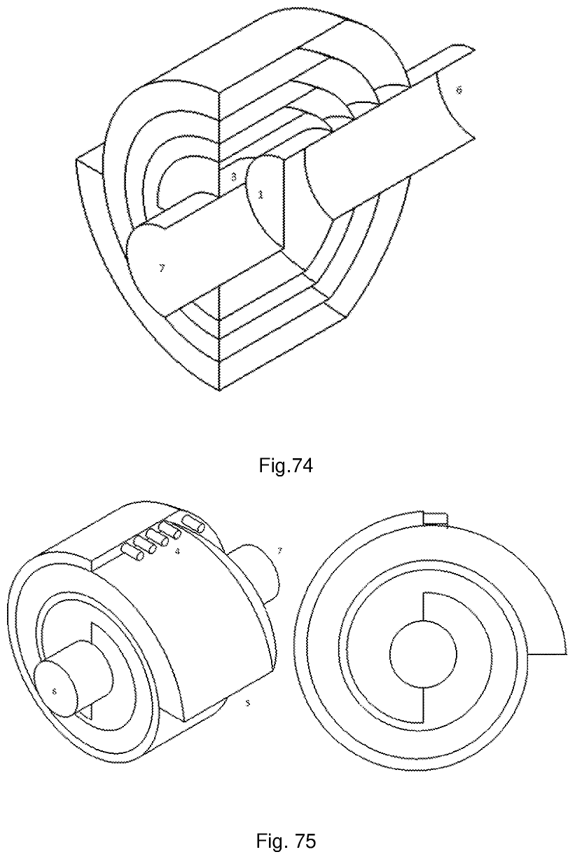

The spiral heat exchanger can be designed as a combination of both planar and spiral types. The design of this type of heat exchanger is like cutting a planar and a three-dimensional spiral heat exchangers with the same spirals so that they can connect to each other (FIG. 73).

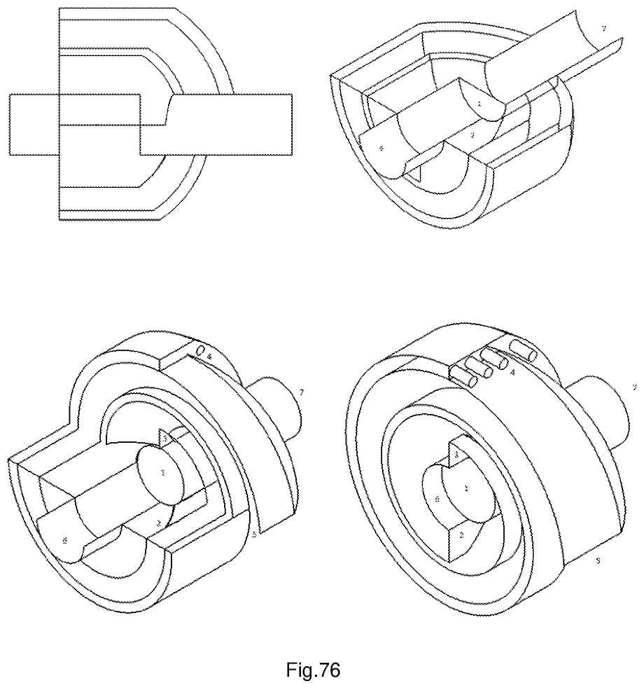

This type of heat exchanger, like other types of heat exchangers, can be designed with unequal ducts. (FIGS. 75 and 76).

FIG. 75 shows a spiral heat exchanger which is a combination of two ducts with different volumes (a combination of three dimensional spiral and planar spiral heat exchanger). The center of the heat exchanger is formed by the method of cut tubes and separator plates.

FIG. 76 shows a section view of the integrated spiral heat exchanger, which has two ducts with different volumes (combination of three dimensional spiral and planar spiral heat exchanger). The center of the heat exchanger is formed by the method of cut pipes and separator plates.

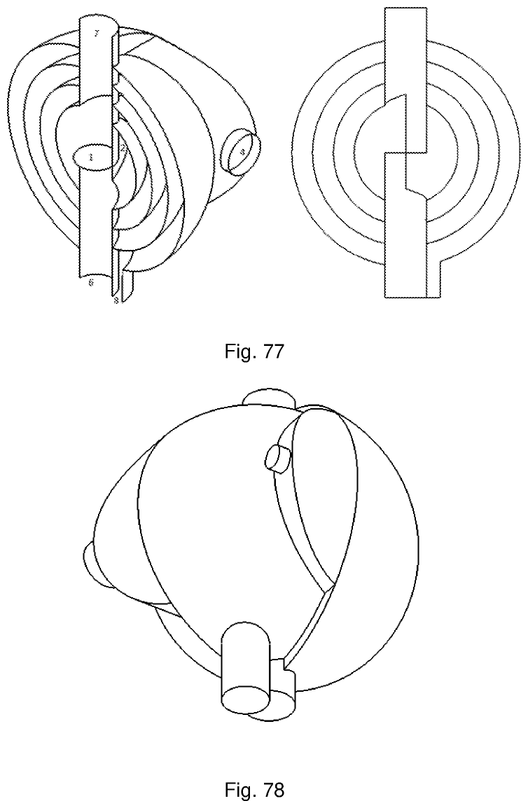

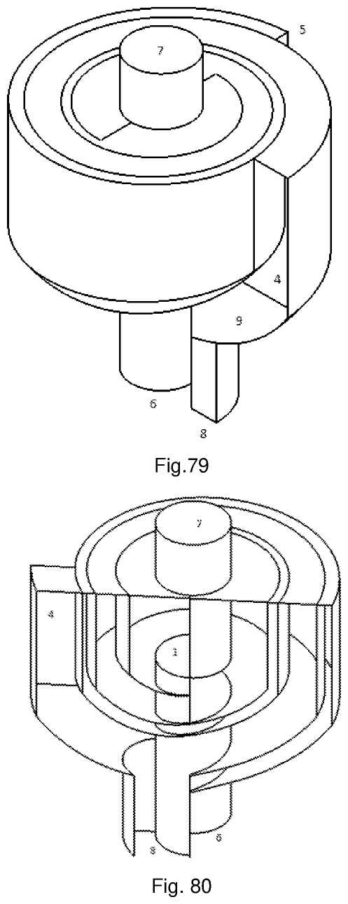

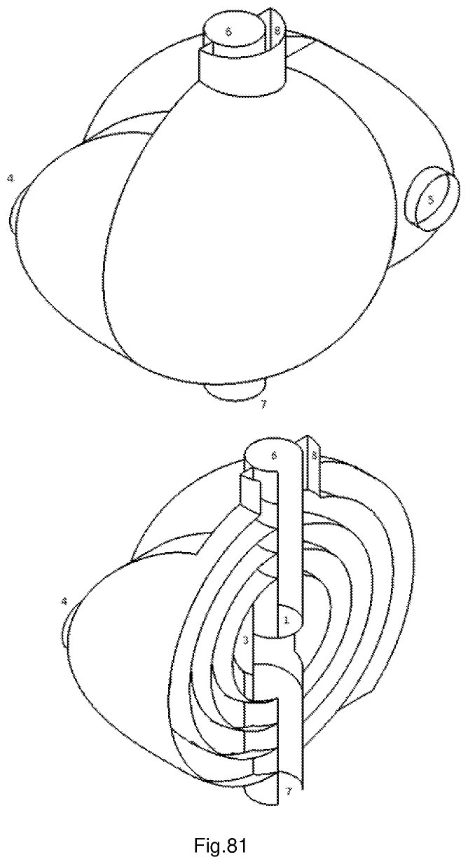

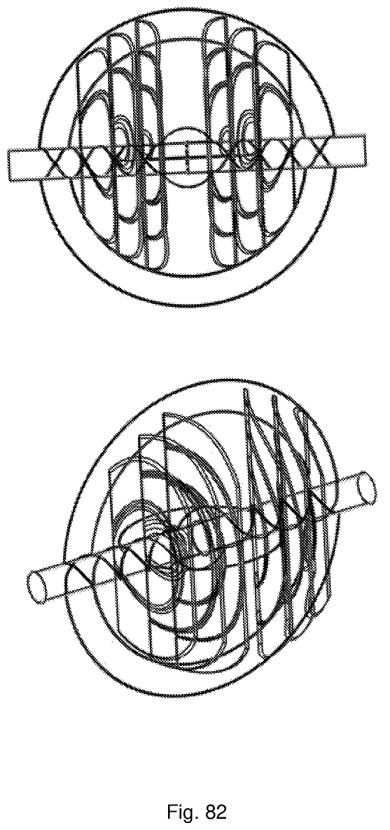

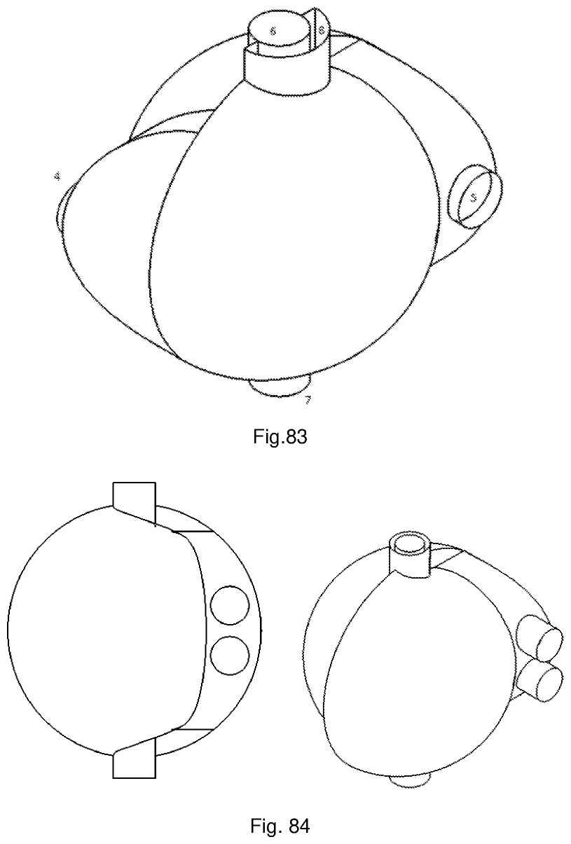

Spiral heat exchangers can also be used for condensation, distillation, boiling and evaporation of fluids. If we want to use a three-dimensional spiral heat exchanger for distillation, we can connect a tube to the lower part of the outer shell of one of the ducts and use this tube to remove the distilled fluid. (FIGS. 77 and 78) This type of design allows the heat exchanger to be used for distillation and separation of multiphase fluids.

The fluid (can be multiphase) enters the gaseous form from tube 6 (bottom tube) to the first duct and cools in contact with the walls. The distilled portion of the fluid exits the orifice 8 and the other gaseous portion exits the tube 4. (Pipe 4 can be connected to the same shell a little higher) If the lower tube is connected to the outer shell of the other conductor duct, the fluid (which can be multiphase) can be directed from the outer shell into the duct, so that part of the distilled fluid leaves the tube connected to the lower duct, and the part exits the upper axial tube in the gaseous form. The distillation tube can also be connected to three-dimensional spiral heat exchangers with unequal volume.

The gaseous fluid (which can be multiphase) enters from the inlet duct 6 to the first duct and cools in contact with the wall. Part of the distilled fluid exits the outlet 8 and the other part exits the orifice 4. Distillation methods in space spiral heat exchangers can be used as distillation trays. If heat exchanger use as an evaporator, it can connect a tube to the upper part of the outer shell of one of the ducts and use this tube to remove the evaporated fluid.

Parabolic spiral heat exchangers can have blades for greater thermal efficiency in some flow regimes, higher pressure tolerances, or greater pressure drop in one or both of their ducts.

The blades can be in the form of hills and valleys, or connect two walls like a column, or direct the fluid flow to a part of the heat exchanger. It is also possible to use a wired network in one of the ducts (for example, when surface evaporation is considered in one of the ducts or when we want to have a wired network in the distiller for better distillation and to prevent foaming) If one wants to react in one of the ducts (such as burning in the boiler), It is necessary to inject two or more fluids into each duct, for this purpose, more than one pipe can be added to each inlet or outlet duct. (FIG. 83)

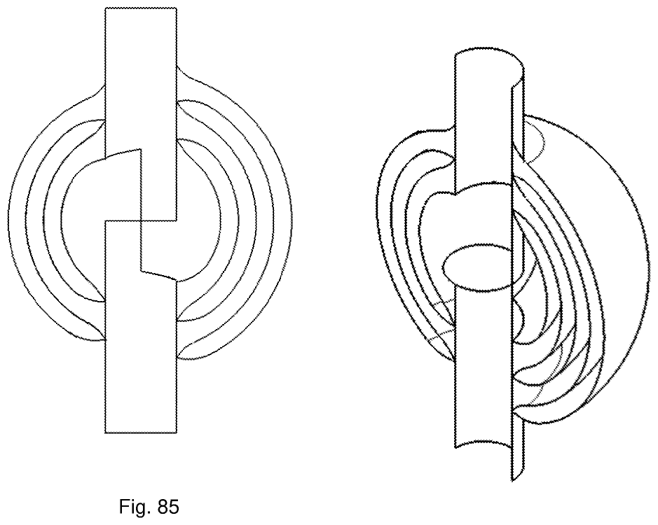

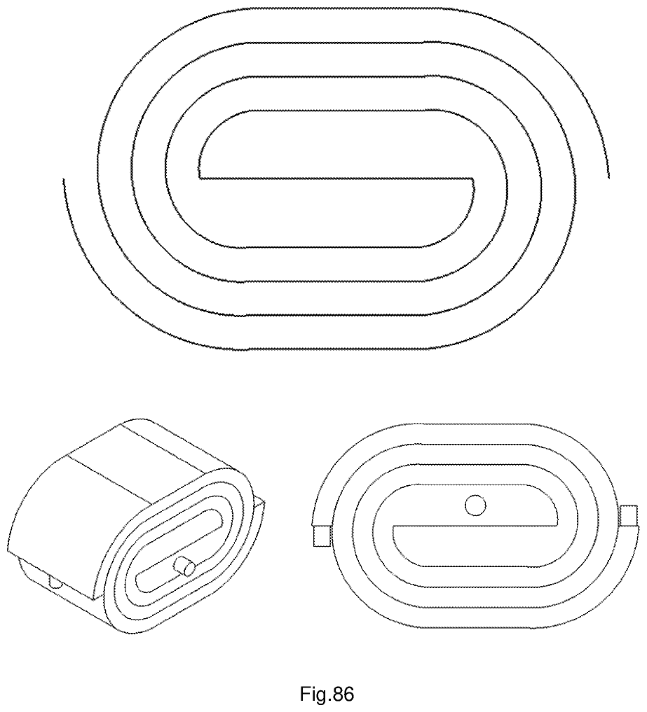

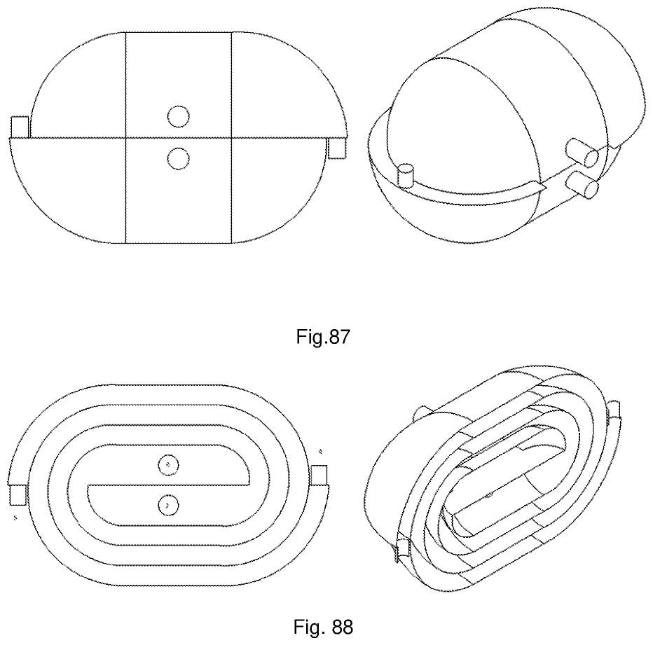

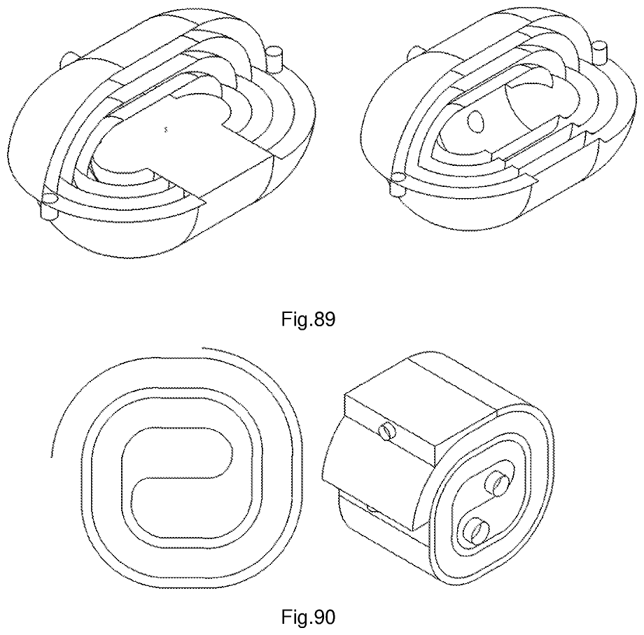

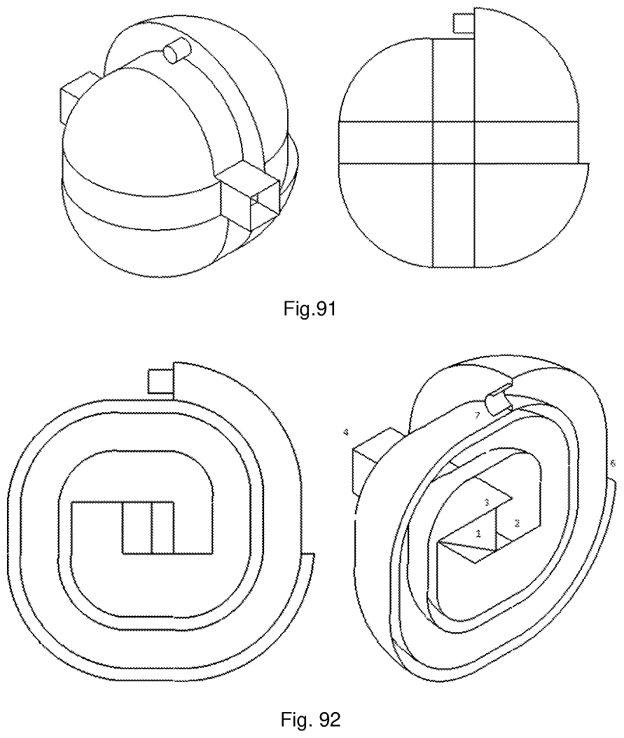

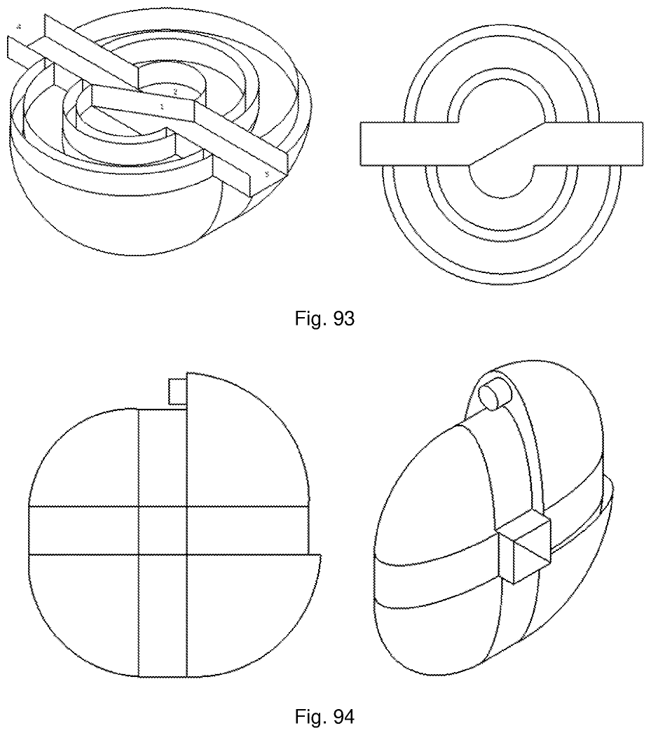

In the design of a three-dimensional spiral heat exchanger, part of the axial tube of each duct is in contact with the same duct. Fixing this issue will improve the thermal performance of the heat exchanger, so these parts can be insulated or modified by designing the adjacent three-dimensional spiral. To achieve this, we bend the sides of the three-dimensional spiral shell upwards and the sides of the other three-dimensional spiral shells bend downwards. (FIG. 85)

Other types of spirals such as Archimedean, logarithmic, Fibonacci, etc. can also be used to design heat exchangers. The main geometry od spirals can also be designed so that the size of the curve step in the inner layers is larger than the outer layers. In many cases, the geometry of the heat exchanger must be compatible with the space which it is installed in order to use the maximum possible volume in the desired space for heat transfer. Therefore, nested shells with straight lines can also be used to form spiral heat exchangers. (FIG. 81)

In the related figures of this embodiment, pipes 4 and 6 are connected to the first duct and pipes 5 and 7 are connected to the second duct. Separator plate 1 also prevents two fluids from mixing together. To enclose the spiral heat exchanger, the primary spiral can be drawn in both directions.

In the pictures related to this type of design, pipes 4 and 6 are connected to the first duct and pipes 5 and 7 are connected to the second duct. Different reference geometries such as curved, broken, distorted, etc. can be used to design this type of heat exchangers.

To make a spiral heat exchanger with curved or angled plates, the plates can be angled, curved or distorted in the first stage, and then they can be bent in the spiral direction.

To make a three-dimensional spiral heat exchanger, the shell can be divided into different parts. For example, if the spiral shell is the result of a 720 degree rotation on the spiral, the shell can be divided into parts, each of which is 180 degrees geometry. For example, the first part of the spiral geometry period from 0 degrees to 180 degrees, the second part of the spiral geometry period from 180 degrees to 360 degrees, the third part of the spiral geometry period from 360 degrees to 540 degrees, the fourth part of the period Spiral geometry from 540 to 720 degrees

By designing different parts of each shell, they can be produced with different production methods such as 3D printing, rapid prototyping, casting and milling.

A variety of pressing methods, including deep drawing, can also be used to make one-piece parts. It is also possible to divide each part into two or more parts and lateral part act as a deep die for each new part. Presses can also be used to cut and bend sheets to make volumetric expansion methods.

In the end, after producing all the parts and components, by assembling them, the whole heat exchanger is made. First, the center of the sphere and the separator plates are made, and then welding is done by placing smaller parts of both shells on the center of the sphere, and in the same way, the parts are welded from smaller to larger. In the last step, the pipes connected to the shell are installed and if necessary, the centrifuge is connected to the heat exchanger, and finally the walls related to the sound insulation are added around the exchanger and the air inlet and outlet walls.

One of the applications of heat exchangers is their use to exchange heat with ambient fluid. These heat exchangers can be used for this purpose if one of the ducts is completely left open in the space spiral heat exchanger or an opening is installed to direct the flow to the outer shell. In this case, it can be used in transportation as an alternative to the radiator in such a way that the air flow is directed into the heat exchanger by moving the vehicle.

To enter more fluid into the heat exchanger in the inlet duct, an opening can be installed to direct more current into the heat exchanger. If the purpose is to exchange the fluid with the air inside the room or building, we can install a centrifuge next to the heat exchanger to create suction at the outlet of the axial tube, causing current to flow in the heat exchanger. (Due to the pressure drop inside this type of heat exchanger, the use of a centrifuge is suitable for this purpose). If this type of radiator is used in buildings, it can be covered with a chamber, in which case the passage of pipes that transfer fluid through the central heating and cooling system to the heat exchanger is installed in the chamber wall.

In this case, the wall of the heat exchanger can also have the property of absorbing sound waves. Walls can also be installed to absorb sound at the inlet and outlet of the fluid.

This design can also be used in the thermal cycle if the hot water inlet to the heat exchanger is to dissipate heat from a special device (cooling various types of heatsinks, electronic devices, motors and industrial devices).

This type of heat exchanger can be used to generate heat, heat transfer and energy recovery in thermal cycles. For example, in refining, petrochemical, power plant, metal production and operations, dryers, condensers, distillers can be used as heat exchangers, condensers, distillers, reactants, evaporators and boilers.

To design the heat exchanger in such a way that it can withstand more pressure and at the same time its mass is as low as possible, the thickness of the walls in different parts of pipes and tubes can be defined unequally or composite structures for this purpose can be defined. Took advantage. For example, the outer shell of the heat exchanger can be thicker and made of composite material

### Method of Production

3D printing techniques can be used to make these type of heat exchangers. Molding methods can also be used to cast the heat exchanger, in one embodiment; the method is to build the center of the heat exchanger at first step (the two tubes in one direction and a separate sheet). Then wrap the two sheets, each of which is connected to one side (top and bottom) of the separating sheet, around the pipe, and at the same time twist the metal sheet on the pipes, which leads to a parabolic spiral, and cut the extra parts of the sheet and then welding the sides to the pipe. Finally, depending on the application of the heat exchanger, one or more pipes can be connected to the other opening of the duct located on the shell, or in some cases, the opening can be in contact with the environment without adding a pipe.

Instead of a tube connects to the shell, the end of the duct that connects to the shell can be left open to be in direct contact with the other fluid. (In air or under water or fluid chambers). The heat exchanger, exchanges fluid directly with the outer medium instead of having a tube on the shell.

Tube 4 is connected to the center of the second duct and the outer shell of this duct can be exchanged directly with another fluid like the other duct of the same heat exchanger or use the tube to exchange fluid with the outer medium.

It is possible to use several tubes on the heat exchanger shell for each of the ducts. As the direct exchange of fluid with the environment can be used for any of the ducts. Other central tubes can also be connected to the center of the heat exchanger, the direction of which cannot be parallel to the axial tubes. The purpose is to transfer the fluid from the center of the heat exchanger to the outside of the heat exchanger or from the outside of the heat exchanger to the center of the heat exchanger using a tube.

### ADVANTAGEOUS EFFECTS OF INVENTION

The unique design offers greater flexibility for optimizing fluid velocity, pressure drop and heat transfer rate.

The nested structure of the heat exchanger makes it able to withstand high pressures and is suitable for cooling pressurized gases or converting gases to liquids.

One of the applications of heat exchangers is their use to exchange heat with ambient fluid. These heat exchangers can be used for this purpose if one of the ducts is completely left open in the space spiral heat exchanger or an opening is installed to direct the flow to the outer shell.

This type of heat exchanger can be used to generate heat, heat transfer and energy recovery in thermal cycles.

1. A three-dimensional spiral heat exchanger comprising:
a set of nested shells wherein a three-dimensional spiral is formed by scaling a reference geometry simultaneously with the rotation around the axis of a basic spiral, forming at least two three-dimensional ducts, each duct having at least one inlet and at least one outlet, one of which is located in the center of the heat exchanger and the other on the shell of the heat exchanger;
at least two tubes connected to the first duct;
at least two tubes connected to the second duct; and
separator plates in the center of the heat exchanger.

2. (canceled)

3. The three-dimensional spiral heat exchanger of claim 1 further comprising an orifice.

4. (canceled)

5. (canceled)

6. The three-dimensional spiral heat exchanger of claim 1 wherein the basic geometry is a semicircle forming a three-dimensional spherical spiral heat exchanger.

7. The three-dimensional spiral heat exchanger of claim 1 wherein the reference geometry is parabolic forming a three-dimensional parabolic spiral heat exchanger.

8. (canceled)

9. (canceled)

10. The three-dimensional spiral heat exchanger of claim 1 wherein the reference geometry is a combination of straight lines and curved lines.

11. The three-dimensional spiral heat exchanger of claim 1 wherein the reference geometry deforms simultaneously with the rotation around the axis.

12. (canceled)

13. The three-dimensional spiral heat exchanger of claim 1 wherein nested shells can be placed in such a way as to create two unequal ducts with different volumes.

14. The three-dimensional spiral heat exchanger of claim 1 wherein the end of the duct that connects to the shell can be left open to be in direct contact with the ambient fluid.

15. (canceled)

16. (canceled)

17. The three-dimensional spiral heat exchanger of claim 1 which is a combination of both planar spiral heat exchangers and three-dimensional heat exchangers.

18. The three-dimensional spiral heat exchanger of claim 1 which is used for condensation of fluids.

19. The three-dimensional spiral heat exchanger of claim 1 which is used for distillation.

20. The three-dimensional spiral heat exchanger of claim 1 which is used for evaporation.

21. The three-dimensional spiral heat exchanger of claim 1 wherein the fluid enters in gaseous form from a bottom tube to the first duct and cools in contact with the walls.

22. The three-dimensional spiral heat exchanger of claim 1 wherein each shell can have blades to enhance thermal efficiency.

23. Three-dimensional spiral heat exchanger of claim 1, wherein a wired network is used in one of the heat exchanger ducts.

24. (canceled)

25. (canceled)

26. (canceled)

27. (canceled)

28. A three-dimensional spiral heat exchanger comprising:
a set of nested plates forming a spiral pattern where each plate is a curved plate, an angled plate, or a combination of curved and angled plates positioned to create a series of spiral ducts;
each duct having at least one inlet and at least one outlet, with one end located centrally within the heat exchanger and the other end on the outer edge of the heat exchanger;
at least two tubes connected to the first duct;
at least two tubes connected to the second duct; and
separator plates in the center of the heat exchanger to maintain the structural integrity and separation of the spiral ducts.
